(19) United States
(12) Patent Application Publication
(10) Pub. No.: US 2009/0289389 A1
(43) Pub. Date: Nov. 26, 2009

(54) CONTAINER AND MANUFACTURING METHOD THEREOF

(75) Inventor: Teh-Kuan LIU, Keelung (TW)

Correspondence Address: FOLEY & LARDNER, 555 South Flower Street, SUITE 3500, LOS ANGELES, CA, 90071-2411, US

(73) Assignee: Thunder Group, Inc.

(21) Appl. No.: 12/535,437

(22) Filed: Aug. 4, 2009

Related U.S. Application Data
(63) Continuation-in-part of application No. 11/951,829, filed on Dec. 6, 2007.

(30) Foreign Application Priority Data
Oct. 26, 2007 (TW) 096140417

(51) Int. Cl. B29C 41/32; B29C 43/18

(52) U.S. Cl. 264/77; 264/319

(57) ABSTRACT

A method for manufacturing a container may include, but is not limited to, providing a female mold and a male mold, at least one of the male mold and the female mold having a predetermined pattern formed thereon; providing a material to at least one of the male mold and the female mold; and forming a container from at least the material with the male mold and the female mold such that the container is formed with at least one of a pattern corresponding to the predetermined pattern of the male mold on an inner surface and a pattern corresponding to the predetermined pattern of the female mold on an outer surface of the container.

### CROSS-REFERENCE TO RELATED PATENT APPLICATIONS

This application is a Continuation-In-Part of U.S. application Ser. No. 11/951,829, filed Dec. 6, 2007, which claims priority to Taiwan Priority Application 096140417, filed Oct. 26, 2007 including the specification, drawings, claims and abstract, each of which are incorporated herein by reference in its entirety.

### BACKGROUND

1. Field of the Invention

Embodiments of the present invention generally relate to containers and manufacturing methods thereof, and, in specific embodiments, to molded containers and manufacturing methods thereof.

2. Related Art

Due to their high temperature resistance and impact resistance, melamine resin containers (among other types of containers) are often used for containing goods. To provide such containers or other types of containers with a beautiful appearance, various patterns are often printed on an inner surface and/or an outer surface of the containers. Conventional printing methods include screen printing and transferring, which involves mechanically printing a predetermined pattern onto the inner surface and/or the outer surface of the container in a planar configuration.

ROC Patent Publication No. M307361 discloses a melamine resin container in a three-dimensional configuration. This melamine resin container is formed by combining and overlapping a plurality of etched-out layers with corresponding convex layers of the etched-out layers. Different color material layers are overlapped to show different color configurations. Specifically, a multi-color and three-dimensional configuration is exhibited through a stacking and sorting process. However, the manufacturing process is difficult to control and the manufacturing process often leads to significant defects in the melamine resin containers.

ROC Patent Publication No. M284323 discloses another method in which a deep color material layer having a pattern different from a light color material layer is overlapped and laminated on the light color material layer to exhibit a multi-color and three-dimensional configuration by using the difference in color and pattern. However, the manufacturing process is difficult to control and the exhibition of the multi-color and three-dimensional configuration is limited.

### SUMMARY OF THE DISCLOSURE

A method of manufacturing a container may include, but is not limited to, any one of or combination of: (i) providing a female mold and a male mold, at least one of the male mold and the female mold having a predetermined pattern formed thereon; (ii) providing a material to at least one of the male mold and the female mold; and (iii) forming a container from at least the material with the male mold and the female mold such that the container is formed with at least one of a pattern corresponding to the predetermined pattern of the male mold on an inner surface and a pattern corresponding to the predetermined pattern of the female mold on an outer surface of the container. The pattern may correspond to the predetermined pattern of the at least one of the male mold and the female mold.

### BRIEF DESCRIPTION OF THE DRAWINGS

FIG. 1A illustrates a mold set for manufacturing a container according to an embodiment of the present invention;

FIG. 1B illustrates a container formed with a mold set according to an embodiment of the present invention;

FIG. 1C is a flow diagram of a manufacturing process for manufacturing a container according to an embodiment of the present invention;

FIG. 2A illustrates a mold set for manufacturing a container according to a second embodiment of the present invention;

FIG. 2B illustrates a container formed with a mold set according to a second embodiment of the present invention;

FIG. 2C is a flow diagram of a manufacturing process for manufacturing a container according to a second embodiment of the present invention;

FIG. 3A illustrates a mold set for manufacturing a container according to a third embodiment of the present invention;

FIG. 3B illustrates a container formed with a mold set according to a third embodiment of the present invention;

FIG. 3C is a flow diagram of a manufacturing process for manufacturing a container according to a third embodiment of the present invention;

FIG. 4A illustrates a portion of a mold set for manufacturing a container according to a fourth embodiment of the present invention;

FIG. 4B illustrates a portion of a mold set for manufacturing a container according to a fourth embodiment of the present invention;

FIG. 4C illustrates a container formed with a mold set according to a fourth embodiment of the present invention;

FIG. 4D is a flow diagram of a manufacturing process for manufacturing a container according to an embodiment of the present invention;

FIG. 5A illustrates a portion of a mold set for manufacturing a container according to a fifth embodiment of the present invention;

FIG. 5B illustrates a portion of a mold set for manufacturing a container according to a fifth embodiment of the present invention;

FIG. 5C illustrates a container formed with a mold set according to a fifth embodiment of the present invention;

FIG. 5D is a flow diagram of a manufacturing process for manufacturing a container according to an embodiment of the present invention;

FIG. 6A illustrates a portion of a mold set for manufacturing a container according to a sixth embodiment of the present invention;

FIG. 6B illustrates a portion of a mold set for manufacturing a container according to a sixth embodiment of the present invention;

FIG. 6C illustrates a container formed with a mold set according to a sixth embodiment of the present invention; and

FIG. 6D is a flow diagram of a manufacturing process for manufacturing a container according to an embodiment of the present invention.

### DETAILED DESCRIPTION

Throughout various embodiments discussed in this disclosure, containers for containing goods or the like may be formed using a process employing at least one male mold and at least one female mold by providing appropriate material (e.g., melamine resin) into the at least one male mold and the at least one female mold and fitting the molds together. During the process, the containers may be formed to include various patterns (e.g., protrusions and/or concavities) on an inner and/or outer surface of the container corresponding to similar patterns in the at least one male mold and/or the at least one female mold. In further embodiments, color layers or the like (e.g., a decal) may be applied to the patterns on the inner and/or outer surface of the container to form patterns having a different color or appearance than a remaining portion of the container.

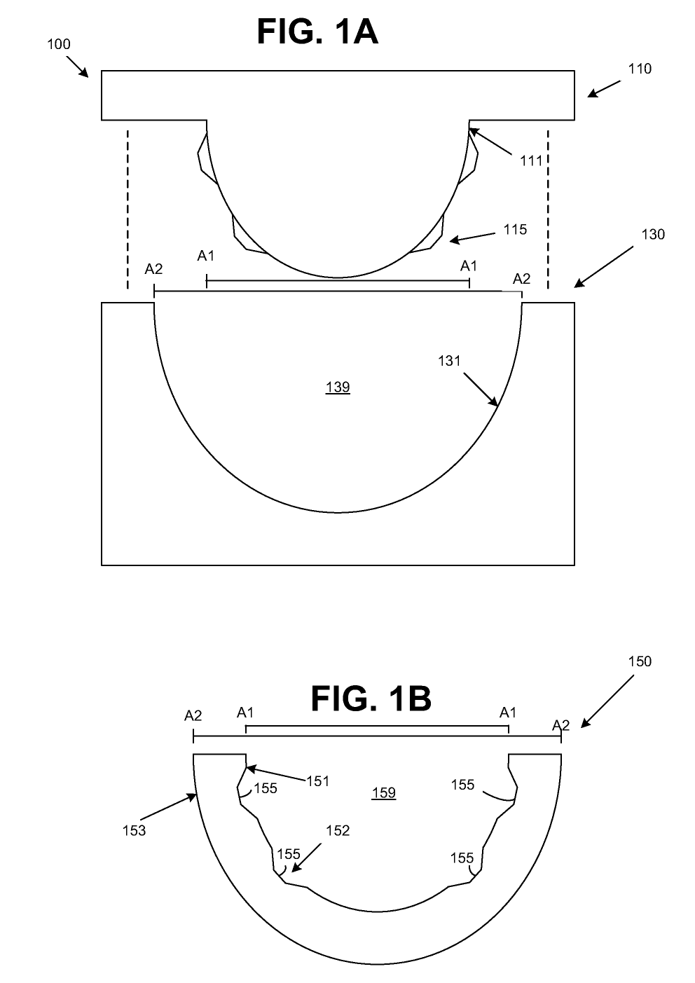

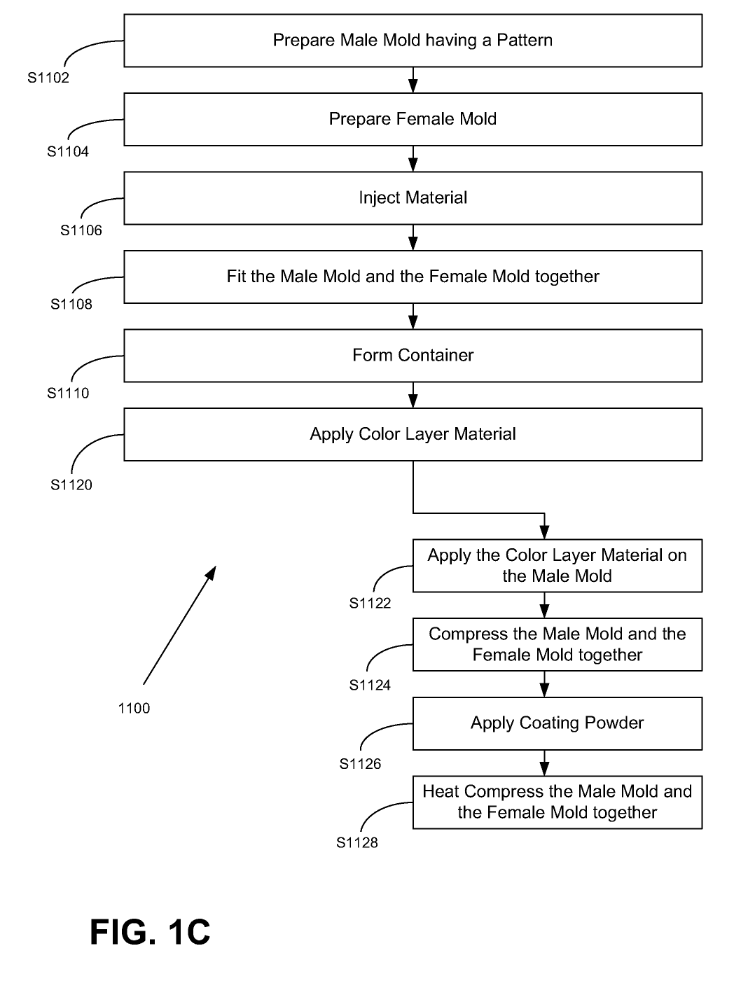

FIGS. 1A-1C show a mold and a flow diagram of a manufacturing process 1100 for making a container 150 using a mold set 100 according to a first embodiment of the present invention. In various embodiments, the mold set 100 may include a male mold 110 and a female mold 130 as will be described.

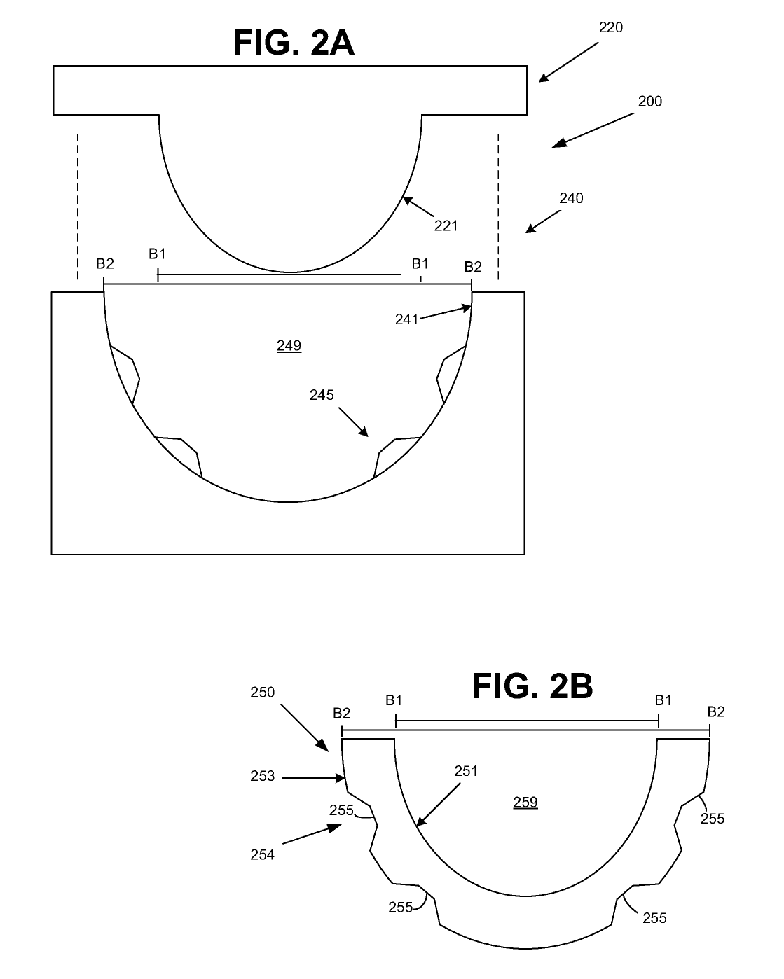

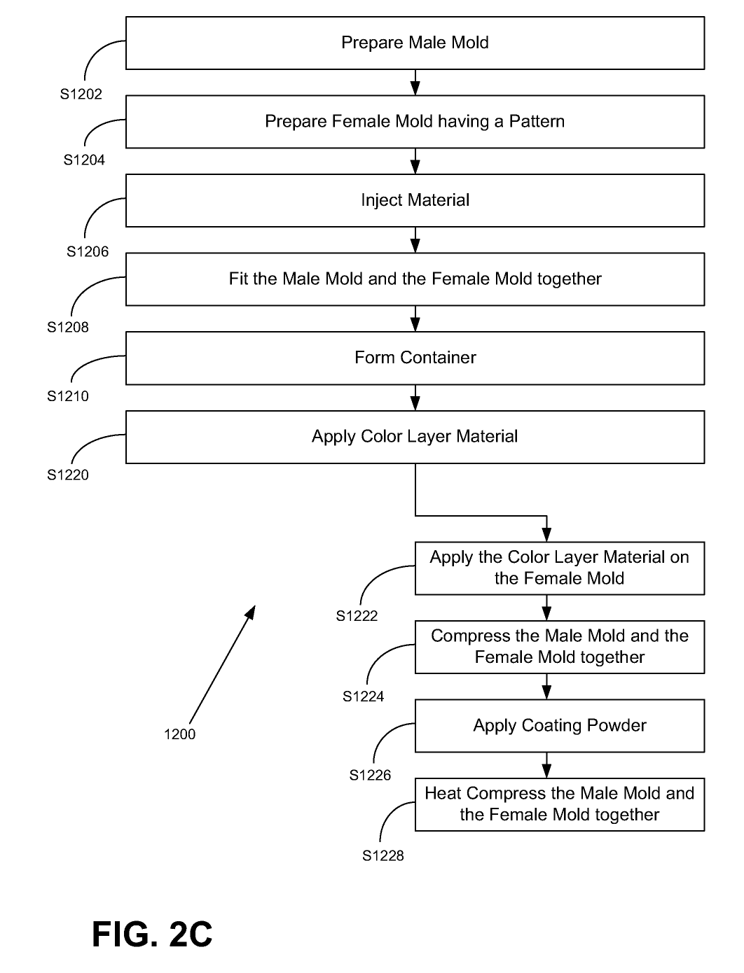

The manufacturing process 1100, the container 150, and/or the mold set 100 may include features similar to, employed as an embodiment of, and/or used with the other manufacturing processes, containers, and/or mold sets discussed throughout the disclosure. It should be understood that the manufacturing process 1100, the container 150, and/or the mold set 100 may also include some or all of the same features and operate in a manner similar to that shown and described in any of the embodiments of FIGS. 2A-6D. In addition, some or all of the features shown in FIGS. 2A-6D may be combined in various ways and included in any of the embodiments shown in FIGS. 1A-1C. Likewise, it should be understood that any of the features of the embodiments of FIGS. 1A-1C may be combined or otherwise incorporated into any of the other embodiments of FIGS. 1A-1C as well as any other embodiment herein discussed. Furthermore, the steps of the manufacturing process 1100 discussed in the disclosure and shown in FIG. 1C serve as a non-limiting example, and thus other embodiments may include additional steps, remove steps, and/or change the order thereof.

With reference to FIGS. 1A-1C, instep S1102 (of FIG. 1C), the male mold 110 may be prepared (e.g., manufactured) or otherwise provided. The male mold 110 may be made of any suitably rigid material such as, but not limited to, metal (e.g., die-cast steel), plastic, glass, composite material, and/or the like. The male mold 110 may be manufactured according to any suitable process, including, but not limited to, with an open-die forge process, close-die forge process, and/or the like.

In various embodiments, the male mold 110 may have a pattern. In some embodiments, the pattern of the male mold 110 may include one or more protrusions 115 (i.e., a three-dimensional structure) on a surface 111 of the male mold 110. For instance, the male mold 110 may have one or more protrusions 115 formed on the surface 111 of the male mold 110 such that, for example, in a case where a material is provided in at least one of the male mold 110 and the female mold 130 and the male mold 110 and the female mold 130 are fit together, a container may be formed having one or more patterns or shapes (e.g., concavities) on an inner surface of the container corresponding to the one or more protrusions 115. As a non-limiting example, the protrusions 115 may include a raised pattern of a flower, fruit, or any other image.

In some embodiments, the protrusions 115 may be formed with the male mold 110 such that, for example, the protrusions 115 and the male mold 110 form a single, unitary body. For example, the protrusions 115 may be formed on/in the male mold 110 by engraving (e.g., laser engraving), etching, water jet cutting, and/or the like. As such, the pattern may be pre-determined to allow a corresponding pattern to be formed on an inner surface of a container, for example, in a case where a material is provided in at least one of the male mold 110 and the female mold 130 and the male mold 110 and the female mold 130 are fit together.

In other embodiments, the protrusions 115 may be provided on the surface 111 of the male mold 110. The protrusions 115 may be provided on the surface 111 of the male mold 110 in any suitable manner such as through, but not limited to, an adhesive material (or other suitable seal), a friction fitting, a press fitting, bonding, melting together, and/or the like. The protrusions 115 may be made of any suitably rigid material such as, but not limited to, metal (e.g., die-cast steel), plastic, glass, composite material, and/or the like.

In some embodiments, the pattern of the male mold 110 may include one or more concavities (not shown). For instance, the male mold 110 may have one or more cavities formed therein (or thereon). As such, the male mold 110 and the female mold 130 may be used to form a container having one or more patterns or shapes (e.g., protrusions) on an inner surface of the container corresponding to the one or more concavities, for example, in a case where a material is provided in at least one of the male mold 110 and the female mold 130 and the male mold 110 and the female mold 130 are fit together. As a non-limiting example, the concavities may include a depressed pattern of a flower, fruit, or any other image.

In various embodiments, the pattern (e.g., protrusions 115, concavities, and/or the like) of the male mold 110 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the pattern (e.g., protrusions 115, concavities, and/or the like) of the male mold 110 may be formed or otherwise provided through an etching process that may include, but is not limited to, forming a mold having a pattern via a reactive ion etching (RIE) method.

In step S1104 (of FIG. 1C), the female mold 130 may be prepared (e.g., manufactured) or otherwise provided. The female mold 130 may be configured to receive at least a portion of the male mold 110. For instance, the female mold 130 may have an accommodating space 139 for receiving the male mold 110.

The female mold 130 may be made of any suitably rigid material such as, but not limited to, metal (e.g., die-cast steel), plastic, glass, composite material, and/or the like. The female mold 130 may be manufactured according to any suitable process, including, but not limited to, with an open-die forge process, close-die forge process, and/or the like. In some embodiments, the female mold 130 may have a surface 131 that is relatively free of any patterns or the like. As such, for example, in a case where a material is provided in at least one of the male mold 110 and the female mold 130 and the male mold 110 and the female mold 130 are fit together, a container may be formed having an outer surface corresponding to the surface 131 (e.g., relatively smooth) of the female mold 130.

In step S1106 (of FIG. 1C), a material may be injected, placed, or otherwise provided into (or onto) at least one of the molds. For instance, in some embodiments, the material may be injected into the female mold 130, and in some embodiments, the material (or other material) may be injected or placed on the male mold 110. The material may be injected, placed, or otherwise provided into (or onto) the at least one of the molds manually, through associated machinery, and/or the like.

In various embodiments, the material may be a melamine material, such as, but not limited to, a melamine resin material (e.g., M230 manufactured by Chia Yeh Plastic Co., Ltd.). In some embodiments, the material may be, but is not limited to, any one of or combination of: wood pulp (e.g., bamboo fiber), paper, starch, acrylic, materials having at least some melamine material, resins, microwaveable material resins, and/or the like. For example, in some embodiments, the material may include a melamine material (e.g., resin) formed by adding bamboo fiber (or the like) to melamine powder. In some embodiments, the material may be white. In other embodiments, the material may be one or more colors.

In step S1108 (of FIG. 1C), the male mold 110 and the female mold 130 of the mold set 100 may be fit together. In some embodiments, the material may be injected, placed, or otherwise provided into one (or both) of the molds (i.e., step S1106) after the male mold 110 and the female mold 130 have already been fit together (i.e., after step S1108).

Next, in step S1110 (of FIG. 1C), the container 150 may be formed with the mold set 100. For instance, in a case where the material has been injected (or otherwise provided) into one of the molds (e.g., the female mold 130) and the male mold 110 and the female mold 130 are fit together, the container 150 may be formed, for example, through an extrusion molding process. As previously discussed, the female mold 130 and the male mold 110 having the pattern may form the container 150. The container 150 may have an inner surface 151 and an outer surface 153. The inner surface 151 may have one or more patterns or shapes corresponding to the pattern of the male mold 110. For example, in a case where the male mold 110 is provided with the protrusions 115, concavities 152 corresponding to the one or more protrusions 115 may be formed in the inner surface 151 of the container 150. The container 150 may have an interior space 159 formed therein by the male mold 110.

In various embodiments, the male mold 110 may have a width dimension A1. The accommodating space 139 of the female mold 130 may have a width dimension A2. Thus in various embodiments where a container 150 is formed using the male mold and the female mold, the container 150 may have a width dimension A2 that may be the same as the width dimension A2 of the accommodating space 139 of the female mold 130. The interior space 159 of the container 150 may have a width dimension A1 that may be the same as the width dimension A1 of the male mold 110. In various embodiments, the width dimension A1 may range from, but is not limited to, 2.2″ to 45″ and the width dimension A2 may range from, but is not limited to, 3″ to 50″. Thus in such embodiments, the container may have a thickness ranging from, but not limited to, 0.8″ to 5″.

In further embodiments, in step S1120 (of FIG. 1C) a process for applying a color layer (e.g., a film, decal, and/or the like) material 155 to the container 150 may be employed. In some embodiments, the color layer material 155 may be a single color. In other embodiments, the color layer material 155 may be a plurality of colors.

With respect to the process of step S1120, first, in step S1122 (of FIG. 1C), the color layer material 155 may be arranged on the male mold 110. In some embodiments, the color layer material 155 may be arranged on the pattern (e.g., the protrusions 115) of the male mold 110. In other embodiments, the color layer material 155 may be arranged on portions of the male mold 110, in addition to in alternative to the pattern (e.g., the protrusions 115) of the male mold 110. In some embodiments, the color layer material 155 may be provided on the container 150, for example, at least in the concavities 152 of the container 450.

In step S1124 (of FIG. 1C), the male mold 110 may be compressed with the female mold 130 to apply the color layer material 155 to the container 150. In other embodiments, the color layer material 155 may be provided on the male mold 110 prior to the male mold 110 and the female mold 130 being used to form the container 150. Thus in such embodiments, the color layer material 155 may be applied as the container 150 is formed (e.g., step S1110).

In step S1126 (of FIG. 1C), a coating powder (not shown) or glazing powder, such as an over-lay resin (e.g., LG-110, LG-220, LG-250) and/or the like may be applied to the color layer material 155 on the container 150. The coating powder, for example, may prevent the color layer material 155 from peeling off the container 150. In step S1128 (of FIG. 1C), the male mold 110 may be compressed, for example via heat compressing, with the female mold 130 to mold the color layer material 155 on the container 150. In other embodiments, the male mold 110 may be compressed, for example via heat compressing, with the female mold 130 to mold the color layer material 155 on the container 150 without applying the coating powder.

In various embodiments, the mold set 100 (or component(s) thereof) may be placed in or otherwise employed with a molding machine (not shown) (e.g., an extrusion molding machine) during step S1106 (e.g., to provide the material). In some embodiments, the mold set 100 (or component(s) thereof) may be placed in or otherwise employed with the molding machine during step S110 (e.g., to form the container 150). The molding machine may be the same device as the associated machinery for providing the material. In other embodiments, the molding machine may be a different device from the associated machinery for providing the material.

FIGS. 2A-2C show a mold and a flow diagram of a manufacturing process 1200 for making a container 250 using a mold set 200 according to a second embodiment of the present invention. In various embodiments, the mold set 200 may include a male mold 220 and a female mold 240 as will be described.

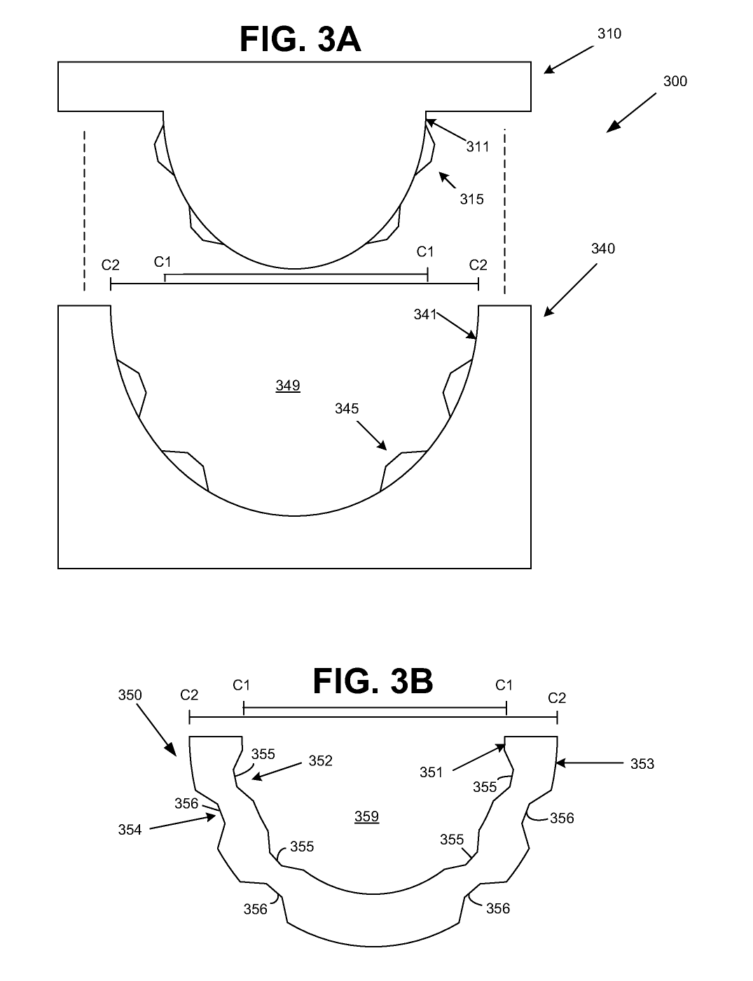

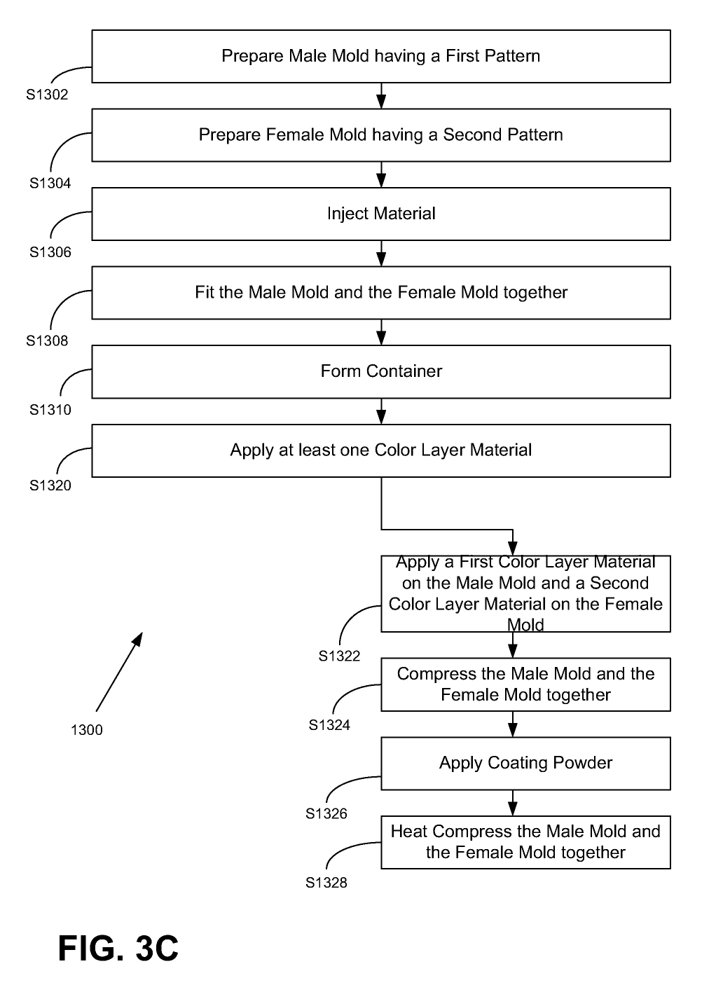

The manufacturing process 1200, the container 250, and/or the mold set 200 may include features similar to, employed as an embodiment of, and/or used with the manufacturing process 1100 (e.g., FIG. 1C), the container 150 (e.g., FIG. 1B), and/or the mold set 100 (e.g., FIG. 1A) and/or the other manufacturing processes, containers, and/or mold sets discussed throughout the disclosure. Although the manufacturing process 1200, the container 250, and/or the mold set 200 may include features similar or used with any of the embodiments of FIGS. 1A-1C, it should be understood that the manufacturing process 1200, the container 250, and/or the mold set 200 may also include some or all of the same features and operate in a manner similar to that shown and described in any of the embodiments of FIGS. 3A-6D. In addition, some or all of the features shown in FIGS. 1A-1C and 3A-6D may be combined in various ways and included in the any of the embodiments shown in FIGS. 2A-2C. Likewise, it should be understood that any of the features of the embodiments of FIGS. 2A-2C may be combined or otherwise incorporated into any of the other embodiments of FIGS. 2A-2C as well as any other embodiment herein discussed. Furthermore, the steps of the manufacturing process 1200 discussed in the disclosure and shown in FIG. 2C serve as a non-limiting example, and thus other embodiments may include additional steps, remove steps, and/or change the order thereof. [0051] With reference to FIGS. 2A-2C, in step S1202 (of FIG. 2C), the male mold 220 may be prepared (e.g., manufactured) or otherwise provided. The male mold 220 may be made of any suitably rigid material such as, but not limited to, metal (e.g., die-cast steel), plastic, glass, composite material, and/or the like. The male mold 220 may be manufactured according to any suitable process, including, but not limited to, with an open-die forge process, close-die forge process, and/or the like. In some embodiments, the male mold 220 may have a surface 221 that is relatively free of any patterns or the like. As such, for example, in a case where a material is provided in at least one of the male mold 220 and the female mold 240 and the male mold 220 and the female mold 240 are fit together, a container may be formed having an inner surface corresponding to the surface 221 (e.g., relatively smooth) of the male mold 220.

In step S1204 (of FIG. 2C), the female mold 240 may be prepared (e.g., manufactured) or otherwise provided. The female mold 240 may be configured to receive at least a portion of the male mold 220. For instance, the female mold 240 may have an accommodating space 249 for receiving the male mold 220. The female mold 240 may be made of any suitably rigid material such as, but not limited to, metal (e.g., die-cast steel), plastic, glass, composite material, and/or the like. The female mold 240 may be manufactured according to any suitable process, including, but not limited to, with an open-die forge process, close-die forge process, and/or the like.

In various embodiments, the female mold 240 may have a pattern. In some embodiments, the pattern of the female mold 240 may include one or more protrusions 245 (i.e., a three-dimensional structure) on a surface 241 of the female mold 240. For instance, the female mold 240 may have one or more protrusions 245 formed on the surface 241 of the female mold 240 such that, for example, in a case where a material is provided in at least one of the male mold 220 and the female mold 240 and the male mold 220 and the female mold 240 are fit together, a container may be formed having one or more patterns or shapes (e.g., concavities) on an outer surface of the container corresponding to the one or more protrusions 245. As a non-limiting example, the protrusions 245 may include a raised pattern of a flower, fruit, or any other image.

In some embodiments, the protrusions 245 may be formed with the female mold 240 such that, for example, the protrusions 245 and the female mold 240 form a single, unitary body. For example, the protrusions 245 may be formed on/in the female mold 240 by engraving (e.g., laser engraving), etching, water jet cutting, and/or the like. As such, the pattern may be pre-determined to allow a corresponding pattern to be formed on an outer surface of a container, for example, in a case where a material is provided in at least one of the male mold 220 and the female mold 240 and the male mold 220 and the female mold 240 are fit together.

In other embodiments, the protrusions 245 may be provided on the surface 241 of the female mold 240. The protrusions 245 may be provided on the surface 241 of the female mold 240 in any suitable manner such as through, but not limited to, an adhesive material (or other suitable seal), a friction fitting, a press fitting, bonding, melting together, and/or the like. The protrusions 245 may be made of any suitably rigid material such as, but not limited to, metal (e.g., die-cast steel), plastic, glass, composite material, and/or the like.

In some embodiments, the pattern of the female mold 240 may include one or more concavities (not shown). For instance, the female mold 240 may have one or more cavities formed therein (or thereon). As such, the male mold 220 and the female mold 240 may be used to form a container having one or more patterns or shapes (e.g., protrusions) on an outer surface of the container corresponding to the one or more concavities, for example, in a case where a material is provided in at least one of the male mold 220 and the female mold 240 and the male mold 220 and the female mold 240 are fit together. As a non-limiting example, the concavities may include a depressed pattern of a flower, fruit, or any other image.

In various embodiments, the pattern (e.g., protrusions 245, concavities, and/or the like) of the female mold 240 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the pattern (e.g., protrusions 245, concavities, and/or the like) of the female mold 240 may be formed or otherwise provided through an etching process that may include, but is not limited to, forming a mold having a pattern via a reactive ion etching (RIE) method.

Instep S1206 (of FIG. 2C), a material maybe injected, placed, or otherwise provided into (or onto) at least one of the molds. For instance, in some embodiments, the material may be injected into the female mold 240, and in some embodiments, the material (or other material) may be injected or placed on the male mold 220. The material may be injected, placed, or otherwise provided into (or onto) the at least one of the molds manually, through associated machinery, and/or the like.

In various embodiments, the material may be a melamine material, such as, but not limited to, a melamine resin material (e.g., M230 manufactured by Chia Yeh Plastic Co., Ltd.). In some embodiments, the material may be, but is not limited to, any one of or combination of: wood pulp (e.g., bamboo fiber), paper, starch, acrylic, materials having at least some melamine material, resins, microwaveable material resins, and/or the like. For example, in some embodiments, the material may include a melamine material (e.g., resin) formed by adding bamboo fiber (or the like) to melamine powder. In some embodiments, the material may be white. In other embodiments, the material may be one or more colors.

In step S1208 (of FIG. 2C), the male mold 220 and the female mold 240 of the mold set 200 may be fit together. In some embodiments, the material may be injected, placed, or otherwise provided into one (or both) of the molds (i.e., step S1206) after the male mold 220 and the female mold 240 have already been fit together (i.e., after step S1208).

Next, in step S1210 (of FIG. 2C), the container 250 may be formed with the mold set 200. For instance, in a case where the material has been injected (or otherwise provided) into one of the molds (e.g., the female mold 240) and the male mold 220 and the female mold 240 are fit together, the container 250 may be formed, for example, through an extrusion molding process. As previously discussed, the male mold 220 and the female mold 240 having the pattern may form the container 250. The container 250 may have an inner surface 251 and an outer surface 253. The outer surface 253 may have one or more patterns or shapes corresponding to the pattern of the female mold 240. For example, in a case where the female mold 240 is provided with the protrusions 245, concavities 254 corresponding to the one or more protrusions 245 may be formed in the outer surface 253 of the container 250. The container 250 may have an interior space 259 formed therein by the male mold 220.

In various embodiments, the male mold 220 may have a width dimension B1. The accommodating space 249 of the female mold 240 may have a width dimension B2. Thus in various embodiments where a container 250 is formed using the male mold 220 and the female mold 240, the container 250 may have a width dimension B2 that may be the same as the width dimension B2 of the accommodating space 249 of the female mold 240. The interior space 259 of the container 250 may have a width dimension B I that may be the same as the width dimension B1 of the male mold 220. In various embodiments, the width dimension B1 may range from, but is not limited to, 2.2″ to 45″ and the width dimension B2 may range from, but is not limited to, 3″ to 50″. Thus in such embodiments, the container may have a thickness ranging from, but not limited to, 0.8″ to 5″.

In further embodiments, in step S1220 (of FIG. 2C) a process for applying a color layer (e.g., a film, decal, and/or the like) material 255 to the container 250 may be employed. In some embodiments, the color layer material 255 may be a single color. In other embodiments, the color layer material 255 may be a plurality of colors.

With respect to the process of step S1220, first, in step S1222 (of FIG. 2C), the color layer material 255 may be arranged on one of the molds of the mold set 200. For instance, in some embodiments, the color layer material 255 may be arranged on the pattern 245 of the female mold 240. In other embodiments, the color layer material 255 may be arranged on portions of the female mold 240, in addition to in alternative to the pattern (e.g., the protrusions 245). In some embodiments, the color layer material 255 may be provided on the container 250, for example, at least on the concavities 254.

In step S1224 (of FIG. 2C), the male mold 220 may be compressed with the female mold 240 to apply the color layer material 255 to the container 250. In other embodiments, the color layer material 255 may be provided on the female mold 240 prior to the male mold 220 and the female mold 240 being used to form the container 250. Thus in such embodiments, the color layer material 255 may be applied as the container is formed (e.g., step S1210).

In step S1226 (of FIG. 2C), a coating powder (not shown) or glazing powder, such as an over-lay resin (e.g., LG-110, LG-220, LG-250) and/or the like may be applied to the color layer material 255 on the container 250. The coating powder, for example, may prevent the color layer material 255 from peeling off the container 250. In step S1228 (of FIG. 2C), the male mold 220 may be compressed, for example via heat compressing, with the female mold 240 to mold the color layer material 255 on the container 250. In other embodiments, the male mold 220 may be compressed, for example via heat compressing, with the female mold 240 to mold the color layer material 255 on the container 250 without applying the coating powder.

In various embodiments, the mold set 200 (or component(s) thereof) may be placed in or otherwise employed with a molding machine (not shown) (e.g., an extrusion molding machine) during step S1206 (e.g., to provide the material). In some embodiments, the mold set 200 (or component(s) thereof) may be placed in or otherwise employed with the molding machine during step S1210 (e.g., to form the container 250). The molding machine may be the same device as the associated machinery for providing the material. In other embodiments, the molding machine may be a different device from the associated machinery for providing the material.

FIGS. 3A-3C show a mold and a flow diagram of a manufacturing process 1300 for making a container 350 using a mold set 300 according to a third embodiment of the present invention. In various embodiments, the mold set 300 may include a male mold 310 and a female mold 340 as will be described.

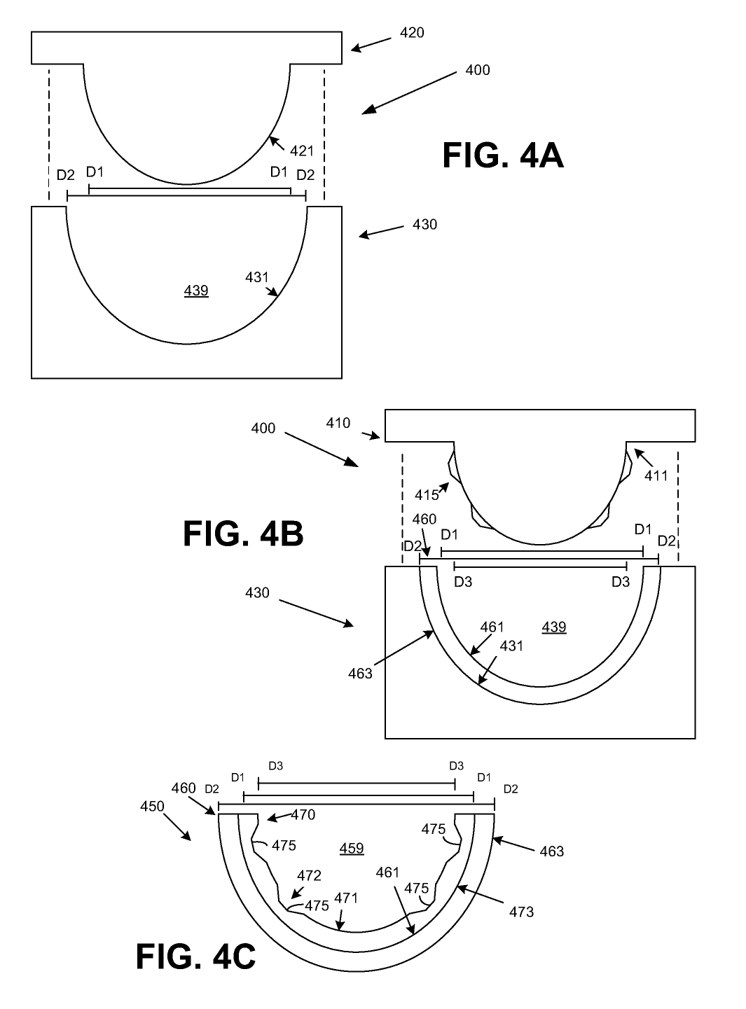

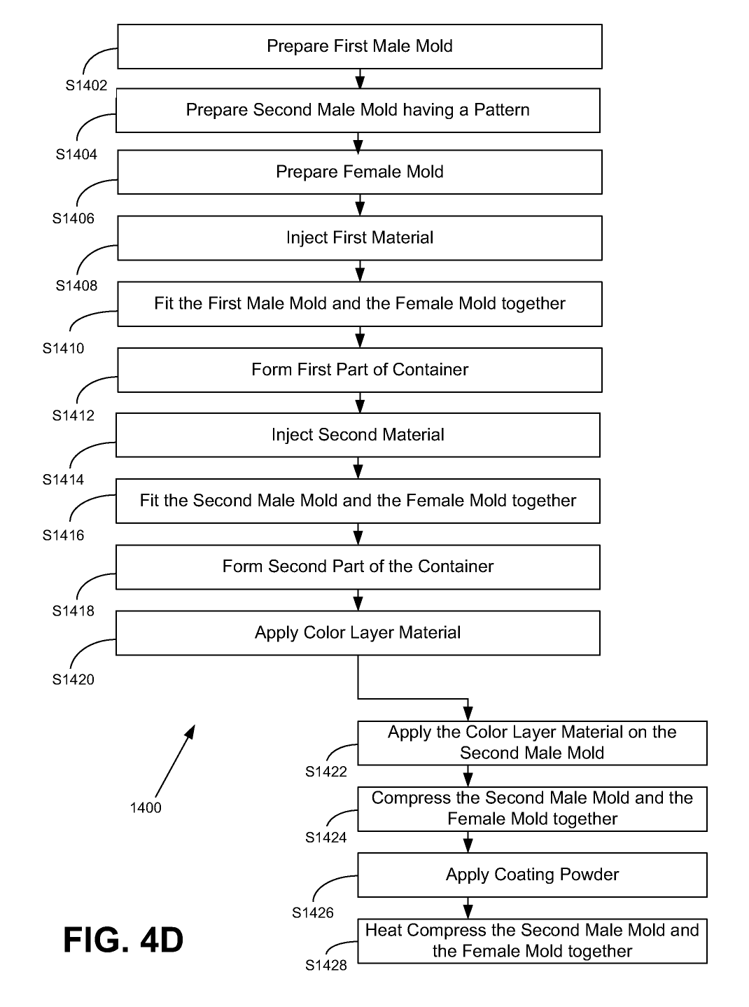

The manufacturing process 1300, the container 350, and/or the mold set 300 may include features similar to, employed as an embodiment of, and/or used with the manufacturing process 1100, 1200 (e.g., FIGS. 1C and 2C), the container 150, 250 (e.g., FIGS. 1B and 2B), and/or the mold set 100, 200 (e.g., FIGS. 1A and 2A) and/or the other manufacturing processes, containers, and/or mold sets discussed throughout the disclosure. Although the manufacturing process 1300, the container 350, and/or the mold set 300 may include features similar or used with any of the embodiments of FIGS. 1A-2C, it should be understood that the manufacturing process 1300, the container 350, and/or the mold set 300 may also include some or all of the same features and operate in a manner similar to that shown and described in any of the embodiments of FIGS. 4A-6D. In addition, some or all of the features shown in FIGS. 1A-2C and 4A-6D may be combined in various ways and included in any of the embodiments shown in FIGS. 3A-3C. Likewise, it should be understood that any of the features of the embodiments of FIGS. 3A-3C may be combined or otherwise incorporated into any of the other embodiments of FIGS. 3A-3C as well as any other embodiment herein discussed. Furthermore, the steps of the manufacturing process 1300 discussed in the disclosure and shown in FIG. 3C serve as a non-limiting example, and thus other embodiments may include additional steps, remove steps, and/or change the order thereof.

With reference to FIGS. 3A-3C, in step S1302 (of FIG. 3C), the male mold 310 may be prepared (e.g., manufactured) or otherwise provided. The male mold 310 may be made of any suitably rigid material such as, but not limited to, metal (e.g., die-cast steel), plastic, glass, composite material, and/or the like. The male mold 310 may be manufactured according to any suitable process, including, but not limited to, with an open-die forge process, close-die forge process, and/or the like.

In various embodiments, the male mold 310 may have a first pattern. In some embodiments, the first pattern of the male mold 310 may include one or more protrusions 315 (i.e., a three-dimensional structure) on a surface 311 of the male mold 310. For instance, the male mold 310 may have one or more protrusions 315 formed on the surface 311 of the male mold 310 such that, for example, in a case where a material is provided in at least one of the male mold 310 and the female mold 340 and the male mold 310 and the female mold 340 are fit together a container may be formed having one or more patterns or shapes (e.g., concavities) on an inner surface of the container corresponding to the one or more protrusions 315. As a non-limiting example, the protrusions 315 may include a raised pattern of a flower, fruit, or any other image.

In some embodiments, the protrusions 315 may be formed with the male mold 310 such that, for example, the protrusions 315 and the male mold 310 form a single, unitary body. For example, the protrusions 315 may be formed on/in the male mold 310 by engraving (e.g., laser engraving), etching, water jet cutting, and/or the like. As such, the first pattern may be pre-determined to allow a corresponding pattern to be formed on an inner surface of a container, for example, in a case where a material is provided in at least one of the male mold 310 and the female mold 340 and the male mold 310 and the female mold 340 are fit together.

In other embodiments, the protrusions 315 may be provided on the surface 311 of the male mold 310. The protrusions 315 may be provided on the surface 311 of the male mold 310 in any suitable manner such as through, but not limited to, an adhesive material (or other suitable seal), a friction fitting, a press fitting, bonding, melting together, and/or the like. The protrusions 315 may be made of any suitably rigid material such as, but not limited to, metal (e.g., die-cast steel), plastic, glass, composite material, and/or the like.

In some embodiments, the first pattern of the male mold 310 may include one or more concavities (not shown). For instance, the male mold 310 may have one or more cavities formed therein (or thereon). As such, the male mold 310 and the female mold 340 may be used to form a container having one or more patterns or shapes (e.g., protrusions) on an inner surface of the container corresponding to the one or more concavities, for example, in a case where a material is provided in at least one of the male mold 310 and the female mold 340 and the male mold 310 and the female mold 340 are fit together. As a non-limiting example, the concavities may include a depressed pattern of a flower, fruit, or any other image.

In various embodiments, the first pattern (e.g., protrusions 315, concavities, and/or the like) of the male mold 310 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the first pattern with an associated laser-engraving machine (e.g., a sealed laser-engraving machine). In various embodiments, the first pattern (e.g., protrusions 315, concavities, and/or the like) of the male mold 310 may be formed or otherwise provided through an etching process that may include, but is not limited to, forming a mold having a pattern via a reactive ion etching (RIE) method.

In step S1304 (of FIG. 3C), the female mold 340 may be prepared (e.g., manufactured) or otherwise provided. The female mold 340 may be configured to receive at least a portion of the male mold 310. For instance, the female mold 340 may have an accommodating space 349 for receiving the male mold 320. The female mold 340 may be made of any suitably rigid material such as, but not limited to, metal (e.g., die-cast steel), plastic, glass, composite material, and/or the like. The female mold 340 may be manufactured according to any suitable process, including, but not limited to, with an open-die forge process, close-die forge process, and/or the like.

In various embodiments, the female mold 340 may have a second pattern. In some embodiments, the second pattern of the female mold 340 may include one or more protrusions 345 (i.e., a three-dimensional structure) on a surface 341 of the female mold 340. For instance, the female mold 340 may have one or more protrusions 345 formed on the surface 341 of the female mold 340 such that, for example, in a case where material is provided in at least one of the male mold 310 and the female mold 340 and the male mold 310 and the female mold 340 are fit together, a container may be formed having one or more patterns or shapes (e.g., concavities) on an outer surface of the container corresponding to the one or more protrusions 345.

As a non-limiting example, the protrusions 345 may include a raised pattern of a flower, fruit, or any other image. In some embodiments, the second pattern (of the female mold 340) may be similar or correspond to the first pattern (of the male mold 310). In other embodiments, the second pattern (of the female mold 340) may be different from the first pattern (of the male mold 310).

In some embodiments, the protrusions 345 may be formed with the female mold 340 such that, for example, the protrusions 345 and the female mold 340 form a single, unitary body. For example, the protrusions 345 may be formed on/in the female mold 340 by engraving (e.g., laser engraving), etching, water jet cutting, and/or the like. As such, the second pattern may be pre-determined to allow a corresponding pattern to be formed on an outer surface of a container, for example, in a case where a material is provided in at least one of the male mold 310 and the female mold 340 and the male mold 310 and the female mold 340 are fit together.

In other embodiments, the protrusions 345 may be provided on the surface 341 of the female mold 340. The protrusions 345 may be provided on the surface 341 of the female mold 340 in any suitable manner such as through, but not limited to, an adhesive material (or other suitable seal), a friction fitting, a press fitting, bonding, melting together, and/or the like. The protrusions 345 may be made of any suitably rigid material such as, but not limited to, metal (e.g., die-cast steel), plastic, glass, composite material, and/or the like.

In some embodiments, the second pattern of the female mold 340 may include one or more concavities (not shown). For instance, the female mold 340 may have one or more cavities formed therein (or thereon). As such, the male mold 310 and the female mold 340 may be used to form a container having one or more patterns or shapes (e.g., protrusions) on an outer surface of the container corresponding to the one or more concavities, for example, in a case where a material is provided in at least one of the male mold 310 and the female mold 340 and the male mold 310 and the female mold 340 are fit together. As a non-limiting example, the concavities may include a depressed pattern of a flower, fruit, or any other image.

In various embodiments, the second pattern (e.g., protrusions 345, concavities, and/or the like) of the female mold 340 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the second pattern (e.g., protrusions 345, concavities, and/or the like) of the female mold 340 may be formed or otherwise provided through an etching process that may include, but is not limited to, forming a mold having a pattern via a reactive ion etching (RIE) method.

Instep S1306 (of FIG. 3C), a material maybe injected, placed, or otherwise provided into (or onto) at least one of the molds. For instance, in some embodiments, the material may be injected into the female mold 340, and in some embodiments, the material (or other material) may be injected or placed on the male mold 310. The material may be injected, placed, or otherwise provided into (or onto) the at least one of the molds manually, through associated machinery, and/or the like.

In various embodiments, the material may be a melamine material, such as, but not limited to, a melamine resin material (e.g., M230 manufactured by Chia Yeh Plastic Co., Ltd.). In some embodiments, the material may be, but is not limited to, any one of or combination of: wood pulp (e.g., bamboo fiber), paper, starch, acrylic, materials having at least some melamine material, resins, microwaveable material resins, and/or the like. For example, in some embodiments, the material may include a melamine material (e.g., resin) formed by adding bamboo fiber (or the like) to melamine powder. In some embodiments, the material may be white. In other embodiments, the material may be one or more colors.

In step S1308 (of FIG. 3C), the male mold 310 and the female mold 340 of the mold set 300 may be fit together. In some embodiments, the material may be injected, placed, or otherwise provided into one (or both) of the molds (i.e., step S1306) after the male mold 310 and the female mold 340 have already been fit together (i.e., after step S1308).

Next, instep S1310 (of FIG. 3C), the container 350 may be formed with the mold set 300. For instance, in a case where the material has been injected (or otherwise provided) into one of the molds (e.g., the female mold 340) and the male mold 310 and the female mold 340 are fit together, the container 350 may be formed, for example, through an extrusion molding process. As previously discussed, the male mold 310 having the first pattern and the female mold 340 having the second pattern may form the container 350.

The container 350 may have an inner surface 351 and an outer surface 353. The inner surface 351 may have one or more patterns or shapes corresponding to the first pattern of the male mold 310. The outer surface 353 may have one or more patterns or shapes corresponding to the second pattern of the female mold 340. For example, in a case where the female mold 340 is provided with the protrusions 345 and the male mold 310 is provided with the protrusions 315, concavities 354 corresponding to the one or more protrusions 345 may be formed in the outer surface 353 and concavities 352 corresponding to the one or more protrusions 315 may be formed in the inner surface 351 of the container 350. The container 350 may have an interior space 359 formed therein by the male mold 310.

In various embodiments, the male mold 310 may have a width dimension C1. The accommodating space 349 of the female mold 340 may have a width dimension C2. Thus in various embodiments where a container 350 is formed using a male mold 310 having a width dimension C1 and a female mold 340 having an accommodating space 349 having a width dimension C2, the container 350 may have a width dimension C2 that is the same as the width dimension C2 of the accommodating space 349 of the female mold 340. The interior space 359 of the container 350 may have a width dimension C1 that is the same as the width dimension C1 of the male mold 310. In various embodiments, the width dimension C1 may range from, but is not limited to, 2.2″ to 45″ and the width dimension C2 may range from, but is not limited to, 3″ to 50″. Thus in such embodiments, the container may have a thickness ranging from, but not limited to, 0.8″ to 5″.

In further embodiments, in step S1320 (of FIG. 3C) a process for applying at least one color layer (e.g., a film, decal, and/or the like) material to the container 350 may be employed. In some embodiments, any one of the color layer material may be a single color. In other embodiments, any one of the color layer material may be a plurality of colors.

With respect to the process of step S1320, first, in step S1322 (of FIG. 3C), at least one color layer material may be arranged on one or more of the molds of the mold set 300. For instance, in some embodiments, a first color layer material 355 may be arranged on the first pattern (e.g., the protrusions 315) of the male mold 310 and/or a second color layer material 356 may be arranged on the second pattern (e.g., the protrusions 345) of the female mold 340.

In other embodiments, one or both of the color layer materials 355 and 356 may be arranged on portions of their respective mold, in addition to in alternative to the pattern of the mold. In some embodiments, one or both of the color layer materials 355 and 356 may be provided on the container 350, for example, at least on the concavities 352 and/or 354.

In step Si 324 (of FIG. 3C), the male mold 310 may be compressed with the female mold 340 to apply the color layer materials 355 and 356 to the container 350. In other embodiments, the one or both of the color layer materials 355, 356 may be provided on their respective molds prior to the molds being used to form the container 350. Thus in such embodiments, the color layer materials 355, 356 may be applied as the container 350 is formed (e.g., step S1310).

In step S1326 (of FIG. 3C), a coating powder (not shown) or glazing powder, such as an over-lay resin (e.g., LG-110, LG-220, LG-250) and/or the like may be applied to one or both of the color layer materials 355 and 356 on the container 350. The coating powder, for example, may prevent the color layer material 355 from peeling off the container 350. In step S1328 (of FIG. 3C), the male mold 310 may be compressed, for example via heat compressing, with the female mold 340 to mold the color layer materials 355 and 356 on the container 350. In other embodiments, the male mold 310 may be compressed, for example via heat compressing, with the female mold 340 to mold the color layer materials 355 and 356 on the container 350 without applying the coating powder.

In various embodiments, the mold set 300 (or component(s) thereof) may be placed in or otherwise employed with a molding machine (not shown) (e.g., an extrusion molding machine) during step S1306 (e.g., to provide the material). In some embodiments, the mold set 300 (or component(s) thereof) may be placed in or otherwise employed with the molding machine during step S1310 (e.g., to form the container 350). The molding machine may be the same device as the associated machinery for providing the material. In other embodiments, the molding machine may be a different device from the associated machinery for providing the material.

FIGS. 4A-4D show a mold and a flow diagram of a manufacturing process 1400 for making a container 450 using a mold set 400 according to a fourth embodiment of the present invention. In various embodiments, the mold set 400 may include a first male mold 420, a second male mold 410, and a female mold 430 as will be described.

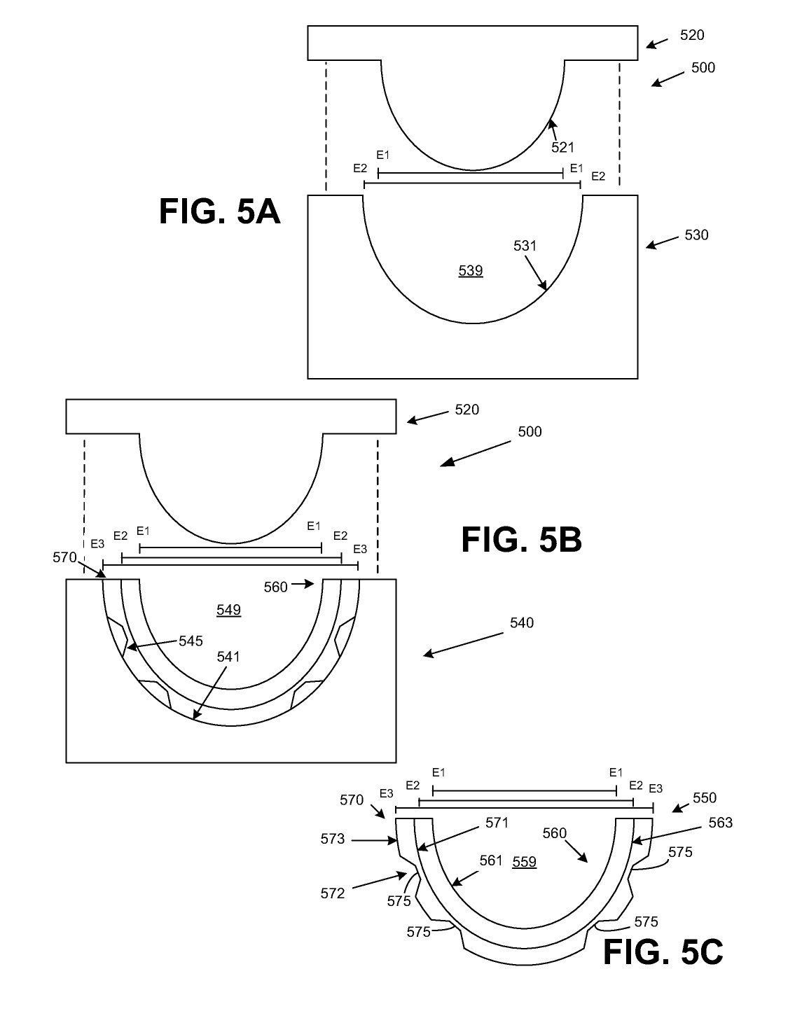

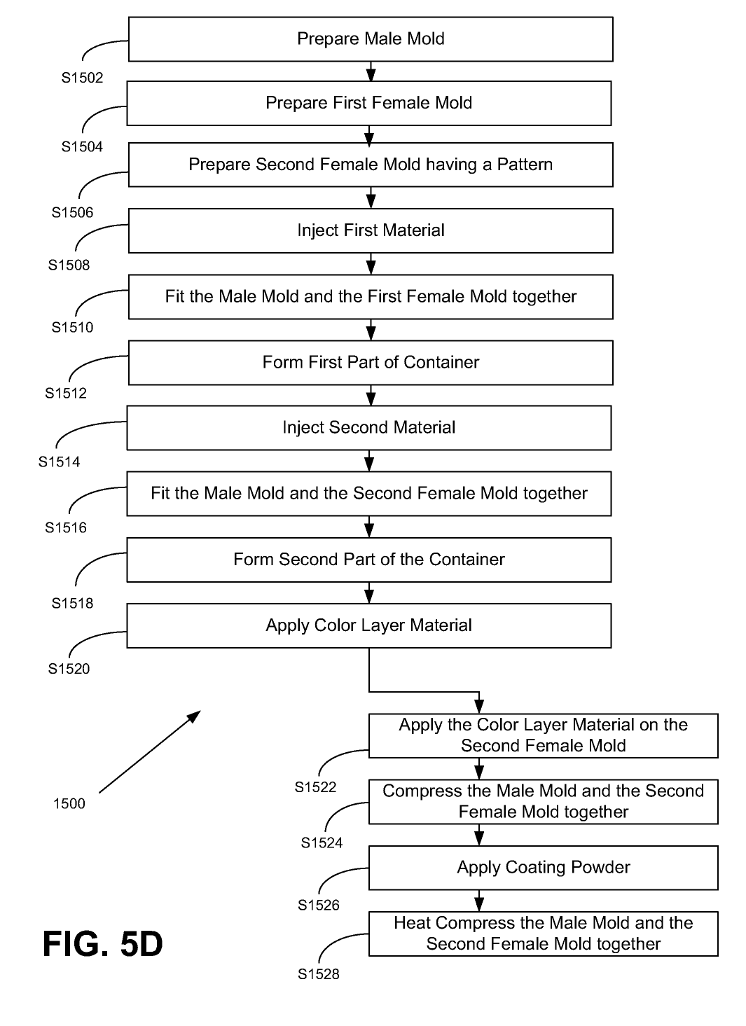

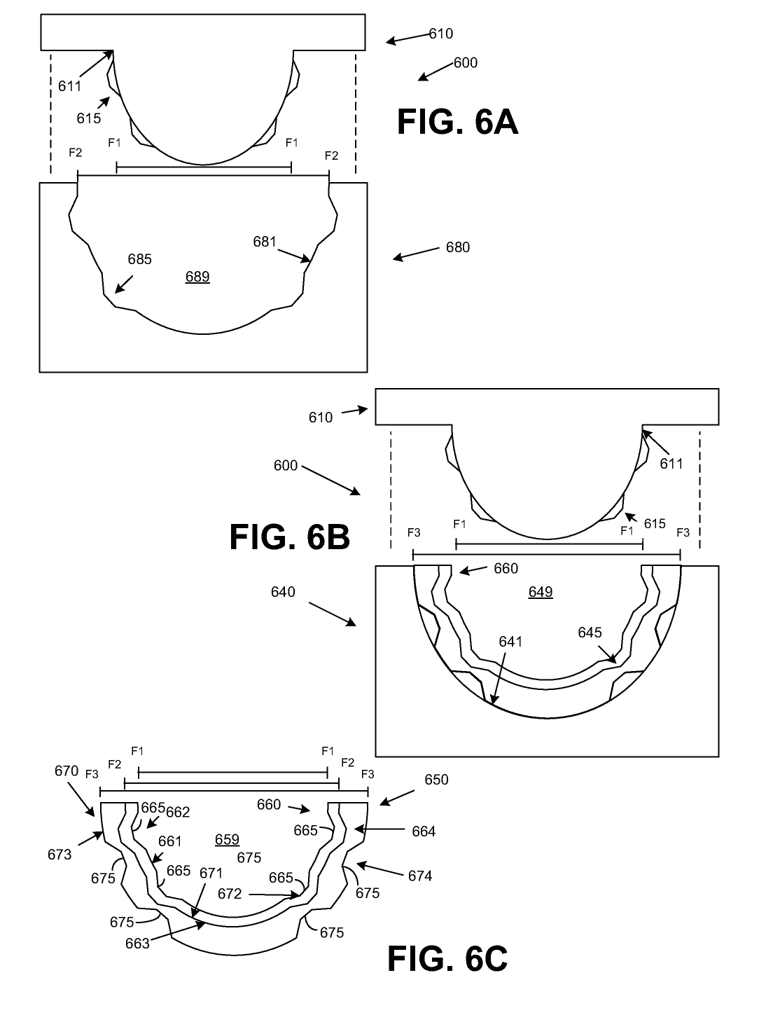

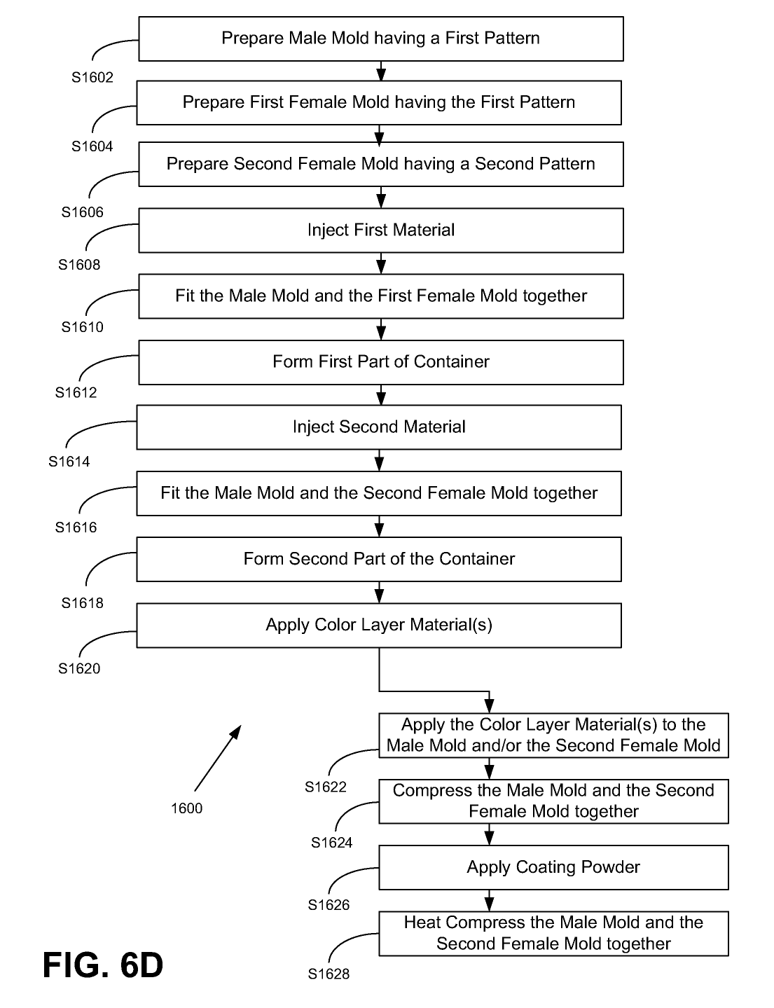

The manufacturing process 1400, the container 450, and/or the mold set 400 may include features similar to, employed as an embodiment of, and/or used with the manufacturing process 1100, 1200, 1300 (e.g., FIGS. 1C, 2C, and 3C), the container 150, 250, 350 (e.g., FIGS. 1B, 2B, and 3B), and/or the mold set 100, 200, 300 (e.g., FIGS. 1A, 2A, and 3A) and/or the other manufacturing processes, containers, and/or mold sets discussed throughout the disclosure. Although the manufacturing process 1400, the container 450, and/or the mold set 400 may include features similar or used with any of the embodiments of FIGS. 1A-3C, it should be understood that the manufacturing process 1400, the container 450, and/or the mold set 400 may also include some or all of the same features and operate in a manner similar to that shown and described in any of the embodiments of FIGS. 5A-6D. In addition, some or all of the features shown in FIGS. 1A-3C and 5A-6D may be combined in various ways and included in any of the embodiments shown in FIGS. 4A-4D. Likewise, it should be understood that any of the features of the embodiments of FIGS. 4A-4D may be combined or otherwise incorporated into any of the other embodiments of FIGS. 4A-4D as well as any other embodiment herein discussed. Furthermore, the steps of the manufacturing process 1400 discussed in the disclosure and shown in FIG. 4D serve as a non-limiting example, and thus other embodiments may include additional steps, remove steps, and/or change the order thereof.

With reference to FIGS. 4A-4D, in step S1402 (of FIG. 4D), the first male mold 420 may be prepared (e.g., manufactured) or otherwise provided. The first male mold 420 may be made of any suitably rigid material such as, but not limited to, metal (e.g., die-cast steel), plastic, glass, composite material, and/or the like. The first male mold 420 may be manufactured according to any suitable process, including, but not limited to, with an open-die forge process, close-die forge process, and/or the like. In some embodiments, the first male mold 420 may have a surface 421 that is relatively free of any patterns or the like. As such, for example, in a case where a material is provided in at least one of the first male mold 420 and the female mold 430 and the first male mold 420 and the female mold 430 are fit together, a container may be formed having an inner surface corresponding to the surface 421 (e.g., relatively smooth) of the first male mold 420.

In step S1404 (of FIG. 4D), the second male mold 410 may be prepared (e.g., manufactured) or otherwise provided. The second male mold 410 may be made of any suitably rigid material such as, but not limited to, metal (e.g., die-cast steel), plastic, glass, composite material, and/or the like. The second male mold 410 may be manufactured according to any suitable process, including, but not limited to, with an open-die forge process, close-die forge process, and/or the like.

In various embodiments, the second male mold 410 may have a pattern. In some embodiments, the pattern of the second male mold 410 may include one or more protrusions 415 (i.e., a three-dimensional structure) on a surface 411 of the second male mold 410. For instance, the second male mold 410 may have one or more protrusions 415 formed on the surface 411 of the second male mold 410 such that, for example, in a case where a material is provided in at least one of the second male mold 410 and the female mold 430 and the second male mold 430 and the female mold 430 are fit together, a container (or portion thereof) may be formed having one or more patterns or shapes (e.g., concavities) on an inner surface of the container corresponding to the one or more protrusions 415. As a non-limiting example, the protrusions 415 may include a raised pattern of a flower, fruit, or any other image.

In some embodiments, the protrusions 415 may be formed with the second male mold 410 such that, for example, the protrusions 415 and the second male mold 410 form a single, unitary body. For example, the protrusions 415 may be formed on/in the second male mold 410 by engraving (e.g., laser engraving), etching, water jet cutting, and/or the like. As such, the pattern may be pre-determined to allow a corresponding pattern to be formed on an inner surface of a container, for example, in a case where a material is provided in at least one of the second male mold 410 and the female mold 430 and the second male mold 410 and the female mold 430 are fit together.

In other embodiments, the protrusions 415 may be provided on the surface 411 of the second male mold 410. The protrusions 415 may be provided on the surface 411 of the second male mold 410 in any suitable manner such as through, but not limited to, an adhesive material (or other suitable seal), a friction fitting, a press fitting, bonding, melting together, and/or the like. The protrusions 415 may be made of any suitably rigid material such as, but not limited to, metal (e.g., die-cast steel), plastic, glass, composite material, and/or the like.

In some embodiments, the pattern of the second male mold 410 may include one or more concavities (not shown). For instance, the second male mold 410 may have one or more cavities formed therein (or thereon). As such, the second male mold 410 and the female mold 430 may be used to form a container (or portion thereof) having one or more patterns or shapes (e.g., protrusions) on an inner surface of the container corresponding to the one or more concavities, for example, in a case where a material is provided in at least one of the second male mold 410 and the female mold 430 and the second male mold 410 and the female mold 430 are fit together. As a non-limiting example, the concavities may include a depressed pattern of a flower, fruit, or any other image.

In various embodiments, the pattern (e.g., protrusions 415, concavities, and/or the like) of the second male mold 410 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the pattern (e.g., protrusions 415, concavities, and/or the like) of the second male mold 410 may be formed or otherwise provided through an etching process that may include, but is not limited to, forming a mold having a pattern via a reactive ion etching (RIE) method.

Instep S1406 (of FIG. 4D), the female mold 430 maybe prepared (e.g., manufactured) or otherwise provided. The female mold 430 may be configured to receive at least a portion of the first male mold 420 and the second male mold 410. For instance, the female mold 430 may have an accommodating space 439 for receiving the first male mold 420 and the second male mold 430.

The female mold 430 may be made of any suitably rigid material such as, but not limited to, metal (e.g., die-cast steel), plastic, glass, composite material, and/or the like. The female mold 430 may be manufactured according to any suitable process, including, but not limited to, with an open-die forge process, close-die forge process, and/or the like. In some embodiments, the female mold 430 may have a surface 431 that is relatively free of any patterns or the like. As such, for example, in a case where a material is provided in at least one of the second male mold 410 and the female mold 430 and the second male mold 410 and the female mold 430 are fit together, a container may be formed having an outer surface corresponding to the surface 431 (e.g., relatively smooth) of the female mold 430.

In step S1408 (of FIG. 4D), a first material may be injected, placed, or otherwise provided into (or onto) at least one of the molds. For instance, in some embodiments, the first material may be injected into the female mold 430, and in some embodiments, the first material (or other material) may be injected or placed on the first male mold 420. The first material may be injected, placed, or otherwise provided into (or onto) the at least one of the molds manually, through associated machinery, and/or the like.

In various embodiments, the first material may be a melamine material, such as, but not limited to, a melamine resin material (e.g., M230 manufactured by Chia Yeh Plastic Co., Ltd.). In some embodiments, the first material may be, but is not limited to, any one of or combination of: wood pulp (e.g., bamboo fiber), paper, starch, acrylic, materials having at least some melamine material, resins, microwaveable material resins, and/or the like. For example, in some embodiments, the first material may include a melamine material (e.g., resin) formed by adding bamboo fiber (or the like) to melamine powder. In some embodiments, the first material may be white. In other embodiments, the first material may be one or more colors.

In step S1410 (of FIG. 4D), the first male mold 420 and the female mold 430 of the mold set 400 may be fit together. In some embodiments, the first material may be injected, placed, or otherwise provided into one (or both) of the molds (i.e., step S 1408) after the first male mold 420 and the female mold 430 have already been fit together (i.e., after step S 1410).

Next, instep S1412 (of FIG. 4D), a first part 460 of the container 450 maybe formed with the mold set 400. For instance, in a case where the first material has been injected (or otherwise provided) into one of the molds (e.g., the female mold 430) and the first male mold 420 and the female mold 430 are fit together, the first part 460 of the container 450 may be formed, for example, through an extrusion molding process. The first part 460 of the container 450 may have an inner surface 461 and an outer surface 463.

Instep S1414 (of FIG. 4D), a second material maybe injected, placed, or otherwise provided into (or onto) at least one of the molds. For instance, in some embodiments, the second material may be injected into the female mold 430, for example, onto the first part 460 of the container 450. In some embodiments, the second material (or other material) may be injected or placed on the second male mold 410. The second material may be injected, placed, or otherwise provided into (or onto) the at least one of the molds (or onto the first part 460 of the container 450) manually, through associated machinery, and/or the like. In further embodiments, the associated machinery may be the same machinery for providing the first material. In other embodiments, the associated machinery may be different from the machinery for providing the first material.

In various embodiments, the second material may be a melamine material, such as, but not limited to, a melamine resin material (e.g., M230 manufactured by Chia Yeh Plastic Co., Ltd.). In some embodiments, the second material may be, but is not limited to, any one of or combination of: wood pulp (e.g., bamboo fiber), paper, starch, acrylic, materials having at least some melamine material, resins, microwaveable material resins, and/or the like. For example, in some embodiments, the second material may include a melamine material (e.g., resin) formed by adding bamboo fiber (or the like) to melamine powder.

In some embodiments, the second material may be white. In other embodiments, the second material may be one or more colors. In some embodiments, the second material may be different from the first material.

In step S1416 (of FIG. 4D), the second male mold 410 and the female mold 430 of the mold set 400 may be fit together. In some embodiments, the second material may be injected, placed, or otherwise provided into one (or both) of the molds (i.e., step S 1414) after the second male mold 410 and the female mold 430 have already been fit together (i.e., after step S1416).

Next, instep S1418 (of FIG. 4D), a second part 470 of the container 450 maybe formed with the mold set 400. The first part 460 and the second part 470 may form the container 450. For instance, in a case where the second material has been injected (or otherwise provided) into one of the molds (e.g., the female mold 430) and the second male mold 410 and the female mold 430 are fit together, the second part 470 of the container 450 may be formed, for example, through an extrusion molding process.

As previously discussed, the female mold 430 and the second male mold 410 having the pattern may form the second part 470 of the container 450. The second part 470 of the container 450 may have an inner surface 471 and an outer surface 473. The inner surface 471 may have one or more patterns or shapes corresponding to the pattern of the second male mold 410. For example, in a case where the second male mold 410 is provided with the protrusions 415, concavities 472 corresponding to the one or more protrusions 415 may be formed in the inner surface 471 of the second part 470 of the container 450. The container 450 may have an interior space 459 formed therein, for example, by the second male mold 410.

The outer surface 473 of the second part 470 may be adjacent the inner surface 461 of the first part 460. In some embodiments, the outer surface 473 of the second part 470 may be adjacent the inner surface 461 of the first part 460. In some embodiments, an intermediate layer (not shown) may be provided between the first part 460 and the second part 470, for example, in contact with the inner surface 461 of the first part 460 and/or the outer surface 473 of the second part 470. The intermediate layer may be formed according to, but not limited to, any of the methods for providing a container in its entirety (e.g., the container 150, 250, 350 as described with respect to FIGS. 1A-3C) or a portion (e.g., the first part 460, the second part 470) of a container.

In various embodiments, the first male mold 420 may have a width dimension D1. The accommodating space 439 of the female mold 430 may have a width dimension D2. The second male mold 410 may have a width dimension D3. Thus in various embodiments where a first part 460 of a container 450 is formed using the first male mold 420 and the female mold 430, the first part 460 of the container 450 may have a width dimension D2 that may be the same as the width dimension D2 of the accommodating space 439 of the female mold 430. The interior space of the first part 460 of the container 450 may have a width dimension D1 that may be the same as the width dimension D1 of the first male mold 420. In various embodiments, the width dimension D1 may range from, but is not limited to, 2.2″ to 45″, the width dimension D2 may range from, but is not limited to, 2.6″ to 47.5″, and the width dimension D3 may range from, but is not limited to, 3″ to 50″. Thus in such embodiments, the container may have a thickness ranging from, but not limited to, 0.8″ to 5″.

In embodiments where a second part 470 of the container 450 is formed using the second male mold 410 and the female mold 430 containing the first part 460, the second part 470 of the container 450 may have a width dimension DI that may be the same as the width dimension D1 of the interior space of the first part 460. The interior space of the second part 470 of the container 450 may have a width dimension D3 that is the same as the width dimension D3 of the second male mold 410. Thus in various embodiments, the first part 460 and the second part 470 may form the container 450 such that a width dimension D2 of the container 450 may be the same as the width dimension D2 of the accommodating space 439 of the female mold 430, and the interior space 459 of the container 450 may have a width dimension D3 that may be the same as the width dimension D3 of the second male mold 410.

In further embodiments, in step S1420 (of FIG. 4D) a process for applying at least one color layer (e.g., a film, decal, and/or the like) material to the container 450 may be employed. In some embodiments, the color layer material may be a single color. In other embodiments, the color layer material may be a plurality of colors.

With respect to the process of step S1420, first, in step S1422 (of FIG. 4D), a color layer material 475 may be arranged on the second male mold 410. For instance, in some embodiments, a color layer material 475 may be arranged on the pattern (e.g., the protrusions 415) of the second male mold 410. In other embodiments, the color layer material 475 may be arranged on portions of the second male mold 410, in addition to in alternative to the pattern (e.g., the protrusions 415) of the second male mold 410. In some embodiments, the color layer material 475 may be provided on the second part 470 of the container 450, for example, at least in the concavities 472 of the second part 470 of the container 450.

In step S1424 (of FIG. 4D), the second male mold 410 maybe compressed with the female mold 430 to apply the color layer material 475 to the container 450. In other embodiments, the color layer material 475 may be provided on the second male mold 410 prior to the second male mold 410 and the female mold 430 being used to form the second part 470 of the container 450. Thus in such embodiments, the color layer material 475 may be applied as the second part 470 is formed (e.g., step S1418).

In step S1426 (of FIG. 4D), a coating powder (not shown) or glazing powder, such as an over-lay resin (e.g., LG-110, LG-220, LG-250) and/or the like may be applied to the color layer material 475 on the container 450. The coating powder, for example, may prevent the color layer material 475 from peeling off the container 450. . In step S1428 (of FIG. 4D), the second male mold 410 may be compressed, for example via heat compressing, with the female mold 430 to mold the color layer material 475 on the container 450. In other embodiments, the second male mold 410 may be compressed, for example via heat compressing, with the female mold 430 to mold the color layer material 475 on the container 450 without applying the coating powder.

In various embodiments, the mold set 400 (or components thereof) may be placed in or otherwise employed with a molding machine (not shown) (e.g., an extrusion molding machine) during step S1408 and/or step S1414 (e.g., to provide the first material and/or the second material, respectively). In some embodiments, the mold set 400 (or component(s) thereof) may be placed in or otherwise employed with the molding machine during step S1412 and/or step S1418 (e.g., to form the first part 460 of the container 450 and the second part 470 of the container 450, respectively). The molding machine may be the same device as the associated machinery for providing the first material and/or the second material. In other embodiments, the molding machine may be a different device from the associated machinery for providing the first material and/or the second material.

FIGS. 5A-5D show a mold and a flow diagram of a manufacturing process 1500 for making a container 550 using a mold set 500 according to a fifth embodiment of the present invention. In various embodiments, the mold set 500 may include a male mold 520, a first female mold 530, and a second female mold 540, as will be described.

The manufacturing process 1500, the container 550, and/or the mold set 500 may include features similar to, employed as an embodiment of, and/or used with the manufacturing process 1100, 1200, 1300, 1400 (e.g., FIGS. 1C, 2C, 3C, and 4D), the container 150, 250, 350, 450 (e.g., FIGS. 1B, 2B, 3B, 4C), and/or the mold set 100, 200, 300, 400 (e.g., FIGS. 1A, 2A, 3A, and 4A-4B) and/or the other manufacturing processes, containers, and/or mold sets discussed throughout the disclosure. Although the manufacturing process 1500, the container 550, and/or the mold set 500 may include features similar or used with any of the embodiments of FIGS. 1A-4D, it should be understood that the manufacturing process 1500, the container 550, and/or the mold set 500 may also include some or all of the same features and operate in a manner similar to that shown and described in any of the embodiments of FIGS. 6A-6D. In addition, some or all of the features shown in FIGS. 1A-4D and 6A-6D may be combined in various ways and included in any of the embodiments shown in FIGS. 5A-5D. Likewise, it should be understood that any of the features of the embodiments of FIGS. 5A-5D may be combined or otherwise incorporated into any of the other embodiments of FIGS. 5A-5D as well as any other embodiment herein discussed. Furthermore, the steps of the manufacturing process 1500 discussed in the disclosure and shown in FIG. 5D serve as a non-limiting example, and thus other embodiments may include additional steps, remove steps, and/or change the order thereof.

With reference to FIGS. 5A-5D, in step S1502 (of FIG. 5D), the male mold 520 may be prepared (e.g., manufactured) or otherwise provided. The male mold 520 may be made of any suitably rigid material such as, but not limited to, metal (e.g., die-cast steel), plastic, glass, composite material, and/or the like. The male mold 520 may be manufactured according to any suitable process, including, but not limited to, with an open-die forge process, close-die forge process, and/or the like. In some embodiments, the male mold 520 may have a surface 521 that is relatively free of any patterns or the like. As such, for example, in a case where a material is provided in at least one of the male mold 520 and the first female mold 530 and the male mold 520 and the first female mold 530 are fit together, a container may be formed having an inner surface corresponding to the surface 521 (e.g., relatively smooth) of the male mold 520.

In step S1504 (of FIG. 5D), the first female mold 530 may be prepared (e.g., manufactured) or otherwise provided. The first female mold 520 may be configured to receive at least a portion of the male mold 520. For instance, the first female mold 530 may have an accommodating space 539 for receiving the male mold 520.

The first female mold 530 may be made of any suitably rigid material such as, but not limited to, metal (e.g., die-cast steel), plastic, glass, composite material, and/or the like. The first female mold 530 may be manufactured according to any suitable process, including, but not limited to, with an open-die forge process, close-die forge process, and/or the like. In some embodiments, the first female mold 530 may have a surface 531 that is relatively free of any patterns or the like. As such, for example, in a case where a material is provided in at least one of the male mold 520 and the first female mold 530 and the male mold 520 and the first female mold 530 are fit together, a container may be formed having an outer surface corresponding to the surface 531 (e.g., relatively smooth) of the first female mold 530.

In step S1506 (of FIG. 5D), the second female mold 540 may be prepared (e.g., manufactured) or otherwise provided. The second female mold 540 may be configured to receive at least a portion of the male mold 520. The second female mold 540 may be made of any suitably rigid material such as, but not limited to, metal (e.g., die-cast steel), plastic, glass, composite material, and/or the like. The second female mold 540 may be manufactured according to any suitable process, including, but not limited to, with an open-die forge process, close-die forge process, and/or the like.

In various embodiments, the second female mold 540 may have a pattern. In some embodiments, the pattern of the second female mold 540 may include one or more protrusions 545 (i.e., a three-dimensional structure) on a surface 541 of the second female mold 540. For instance, the second female mold 540 may have one or more protrusions 545 formed on the surface 541 of the second female mold 540 such that, for example, in a case where material is provided in at least one of the male mold 520 and the second female mold 540 and the male mold 520 and the second female mold 540 are fit together, a container (or portion thereof) may be formed having one or more patterns or shapes (e.g., concavities) on an outer surface of the container corresponding to the one or more protrusions 545. As a non-limiting example, the protrusions 545 may include a raised pattern of a flower, fruit, or any other image.

In some embodiments, the protrusions 545 may be formed with the second female mold 540 such that, for example, the protrusions 545 and the second female mold 540 form a single, unitary body. For example, the protrusions 545 may be formed on/in the second female mold 540 by engraving (e.g., laser engraving), etching, water jet cutting, and/or the like. As such, the pattern may be pre-determined to allow a corresponding pattern to be formed on an outer surface of a container (or portion thereof), for example, in a case where a material is provided in at least one of the male mold 520 and the second female mold 540 and the male mold 520 and the second female mold 540 are fit together.

In other embodiments, the protrusions 545 may be provided on the surface 541 of the second female mold 540. The protrusions 545 may be provided on the surface 541 of the second female mold 540 in any suitable manner such as through, but not limited to, an adhesive material (or other suitable seal), a friction fitting, a press fitting, bonding, melting together, and/or the like. The protrusions 545 may be made of any suitably rigid material such as, but not limited to, metal (e.g., die-cast steel), plastic, glass, composite material, and/or the like.

In some embodiments, the pattern of the second female mold 540 may include one or more concavities (not shown). For instance, the second female mold 540 may have one or more cavities formed therein (or thereon). As such, the male mold 520 and the second female mold 540 may be used to form a container (or portion thereof) having one or more patterns or shapes (e.g., protrusions) on an outer surface of the container (or portion thereof) corresponding to the one or more concavities, for example, in a case where a material is provided in at least one of the male mold 520 and the second female mold 540 and the male mold 520 and the second female mold 540 are fit together. As a non-limiting example, the concavities may include a depressed pattern of a flower, fruit, or any other image.

In various embodiments, the pattern (e.g., protrusions 545, concavities, and/or the like) of the second female mold 540 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the pattern (e.g., protrusions 545, concavities, and/or the like) of the second female mold 540 may be formed or otherwise provided through an etching process that may include, but is not limited to, forming a mold having a pattern via a reactive ion etching (RIE) method.

In step S1508 (of FIG. 5D), a first material may be injected, placed, or otherwise provided into (or onto) at least one of the molds. For instance, in some embodiments, the first material may be injected into the first female mold 530, and in some embodiments, the first material (or other material) may be injected or placed on the male mold 520. The first material may be injected, placed, or otherwise provided into (or onto) the at least one of the molds manually, through associated machinery, and/or the like.

In various embodiments, the first material may be a melamine material, such as, but not limited to, a melamine resin material (e.g., M230 manufactured by Chia Yeh Plastic Co., Ltd.). In some embodiments, the first material may be, but is not limited to, any one of or combination of: wood pulp (e.g., bamboo fiber), paper, starch, acrylic, materials having at least some melamine material, resins, microwaveable material resins, and/or the like. For example, in some embodiments, the first material may include a melamine material (e.g., resin) formed by adding bamboo fiber (or the like) to melamine powder. In some embodiments, the first material may be white. In other embodiments, the first material may be one or more colors.

Instep S1510 (of FIG. 5D), the male mold 520 and the first female mold 530 of the mold set 500 may be fit together. In some embodiments, the first material may be injected, placed, or otherwise provided into one (or both) of the molds (i.e., step S1508) after the male mold 520 and the first female mold 530 have already been fit together (i.e., after step S1510).

Next, instep S1512 (of FIG. 5D), a first part 560 of the container 550 maybe formed with the mold set 500. For instance, in a case where the first material has been injected (or otherwise provided) into one of the molds (e.g., the first female mold 530) and the male mold 520 and the first female mold 530 are fit together, the first part 560 of the container 550 may be formed, for example, through an extrusion molding process. The first part 560 of the container 550 may have an inner surface 561 and an outer surface 563.

Instep S1514 (of FIG. 5D), a second material maybe injected, placed, or otherwise provided into (or onto) at least one of the molds. For instance, in some embodiments, the second material may be injected into the second female mold 540. In some embodiments, the second material (or other material) may be injected or placed on the male mold 520, for example, onto the first part 560 of the container 550. The second material may be injected, placed, or otherwise provided into (or onto) the at least one of the molds (or onto the first part 560 of the container 550) manually, through associated machinery, and/or the like. In further embodiments, the associated machinery may be the same machinery for providing the first material. In other embodiments, the associated machinery may be different from the machinery for providing the first material.

In various embodiments, the second material may be a melamine material, such as, but not limited to, a melamine resin material (e.g., M230 manufactured by Chia Yeh Plastic Co., Ltd.). In some embodiments, the second material may be, but is not limited to, any one of or combination of: wood pulp (e.g., bamboo fiber), paper, starch, acrylic, materials having at least some melamine material, resins, microwaveable material resins, and/or the like. For example, in some embodiments, the second material may include a melamine material (e.g., resin) formed by adding bamboo fiber (or the like) to melamine powder.

In some embodiments, the second material may be white. In other embodiments, the second material may be one or more colors. In some embodiments, the second material may be different (e.g., in color, material, texture, and/or the like) from the first material. In other embodiments, the second material may be the same as the first material.

Instep S1516 (of FIG. 5D), the male mold 520 and the second female mold 540 of the mold set 500 may be fit together. In some embodiments, the second material may be injected, placed, or otherwise provided into one (or both) of the molds (i.e., step S 1514) after the male mold 520 and the second female mold 540 have already been fit together (i.e., after step S1516).

Next, instep S1518 (of FIG. 5D), a second part 570 of the container 550 maybe formed with the mold set 500. The first part 560 and the second part 570 may form the container 550. For instance, in a case where the second material has been injected (or otherwise provided) into one of the molds (e.g., the second female mold 540) and the male mold 520 and the second female mold 540 are fit together, the second part 570 of the container 550 may be formed, for example, through an extrusion molding process.

As previously discussed, the male mold 520 and the second female mold 540 having the pattern may form the second part 570 of the container 550. The second part 570 of the container 550 may have an inner surface 571 and an outer surface 573. The outer surface 573 may have one or more patterns or shapes corresponding to the pattern of the second female mold 540. For example, in a case where the second female mold 540 is provided with the protrusions 545, concavities 572 corresponding to the one or more protrusions 545 may be formed in the outer surface 573 of the second part 570 of the container 550. The container 550 may have an interior space 559 formed therein, for example, by the male mold 520.

The outer surface 563 of the first part 560 may be adjacent the inner surface 571 of the second part 570. In some embodiments, the outer surface 563 of the first part 560 may be adjacent (e.g., in contact with) the inner surface 571 of the second part 570. In some embodiments, an intermediate layer (not shown) may be provided between the first part 560 and the second part 570, for example, in contact with the outer surface 563 of the first part 560 and/or the inner surface 571 of the second part 570. The intermediate layer may be formed according to, but not limited to, any of the methods for providing a container in its entirety (e.g., the container 150, 250, 350, 450 as described with respect to FIGS. 1A-4D) or a portion (e.g., the first part 560, the second part 570, and/or the like) of a container.

In various embodiments, the male mold 520 may have a width dimension E1. The accommodating space 539 of the first female mold 530 may have a width dimension E2. The accommodating space 549 of the second female mold 540 may have a width dimension E3. Thus in various embodiments where a first part 560 of a container 550 is formed using the male mold 520 and the first female mold 530, the first part 560 of the container 550 may have a width dimension E2 that may be the same as the width dimension E2 of the accommodating space 539 of the first female mold 530. The interior space of the first part 560 of the container 550 may have a width dimension E1 that may be the same as the width dimension E1 of the male mold 520. In various embodiments, the width dimension E1 may range from, but is not limited to, 2.2″ to 45″, the width dimension E2 may range from, but is not limited to, 2.6″ to 47.5″, and the width dimension E3 may range from, but is not limited to, 3″ to 50″. Thus in such embodiments, the container may have a thickness ranging from, but not limited to, 0.8″ to 5″.

In embodiments where a second part 570 of the container 550 is formed with the first part 560 using the male mold 520 and the second female mold 540, the second part 570 of the container 550 may have a width dimension E3 that may be the same as the width dimension E3 of the interior space 549 of the second female mold 540. The interior space of the second part 570 of the container 550 may have a width dimension E2 that is the same as the width dimension E2 of the first part 560. Thus in various embodiments, the first part 560 and the second part 570 may form the container 550 such that a width dimension E3 of the container 550 may be the same as the width dimension E3 of the accommodating space 549 of the second female mold 540, and the interior space 559 of the container 550 may have a width dimension E1 that may be the same as the width dimension E1 of the male mold 520.

In further embodiments, in step S1520 (of FIG. 5D) a process for applying at least one color layer (e.g., a film, decal, and/or the like) material to the container 550 may be employed. In some embodiments, the color layer material may be a single color. In other embodiments, the color layer material may be a plurality of colors.

With respect to the process of step S1520, first, in step S1522 (of FIG. 5D), a color layer material 575 may be arranged on the second female mold 540. For instance, in some embodiments, a color layer material 575 may be arranged on the pattern (e.g., the protrusions 545) of the second female mold 540. In other embodiments, the color layer material 575 may be arranged on portions of the second female mold 540, in addition to in alternative to the pattern (e.g., the protrusions 545) of the second female mold 540. In some embodiments, the color layer material 575 may be provided on the second part 570 of the container 550, for example, at least in the concavities 572 of the second part 570 of the container 450.

In step S1524 (of FIG. 5D), the male mold 520 may be compressed with the second female mold 540 to apply the color layer material 575 to the container 550. In other embodiments, the color layer material 575 may be provided on the second female mold 540 prior to the male mold 520 and the second female mold 540 being used to form the second part 570 of the container 550. Thus in such embodiments, the color layer material 575 may be applied as the second part 570 is formed (e.g., step S1518).

In step S1526 (of FIG. 5D), a coating powder (not shown) or glazing powder, such as an over-lay resin (e.g., LG-110, LG-220, LG-250) and/or the like may be applied to the color layer material 575 on the container 550. The coating powder, for example, may prevent the color layer material 575 from peeling off the container 550. In step S1528 (of FIG. 5D), the male mold 520 may be compressed, for example via heat compressing, with the second female mold 540 to mold the color layer material 575 on the container 550. In other embodiments, the male mold 520 may be compressed, for example via heat compressing, with the second female mold 540 to mold the color layer material 575 on the container 550 without applying the coating powder.

In various embodiments, the mold set 500 (or components thereof) may be placed in or otherwise employed with a molding machine (not shown) (e.g., an extrusion molding machine) during step S1508 and/or step S1514 (e.g., to provide the first material and/or the second material, respectively). In some embodiments, the mold set 500 (or component(s) thereof) may be placed in or otherwise employed with the molding machine during step S1512 and/or step S1518 (e.g., to form the first part 560 of the container 550 and the second part 570 of the container 550, respectively). The molding machine may be the same device as the associated machinery for providing the first material and/or the second material. In other embodiments, the molding machine may be a different device from the associated machinery for providing the first material and/or the second material.

FIGS. 6A-6D show a mold and a flow diagram of a manufacturing process 1600 for making a container 650 using a mold set 600 according to a sixth embodiment of the present invention. In various embodiments, the mold set 600 may include a male mold 610, a first female mold 680, and a second female mold 640, as will be described.

The manufacturing process 1600, the container 650, and/or the mold set 600 may include features similar to, employed as an embodiment of, and/or used with the manufacturing process 1100, 1200, 1300, 1400, 1500 (e.g., FIGS. 1C, 2C, 3C, 4D, and 5D), the container 150, 250, 350, 450, 550 (e.g., FIGS. 1B, 2B, 3B, 4C, and 5C), and/or the mold set 100, 200, 300, 400, 500 (e.g., FIGS. 1A, 2A, 3A, 4A-4B, and 5A-5B) and/or the other manufacturing processes, containers, and/or mold sets discussed throughout the disclosure. In addition, some or all of the features shown in FIGS. 1A-5D may be combined in various ways and included in any of the embodiments shown in FIGS. 6A-6D. Likewise, it should be understood that any of the features of the embodiments of FIGS. 6A-6D may be combined or otherwise incorporated into any of the other embodiments of FIGS. 6A-6D as well as any other embodiment herein discussed. Furthermore, the steps of the manufacturing process 1600 discussed in the disclosure and shown in FIG. 6D serve as a non-limiting example, and thus other embodiments may include additional steps, remove steps, and/or change the order thereof.

With reference to FIGS. 6A-6D, in step S1602 (of FIG. 6D), the male mold 610 may be prepared (e.g., manufactured) or otherwise provided. The male mold 610 may be made of any suitably rigid material such as, but not limited to, metal (e.g., die-cast steel), plastic, glass, composite material, and/or the like. The male mold 610 may be manufactured according to any suitable process, including, but not limited to, with an open-die forge process, close-die forge process, and/or the like.

In various embodiments, the male mold 610 may have a first pattern. In some embodiments, the first pattern of the male mold 610 may include one or more protrusions 615 (i.e., a three-dimensional structure) on a surface 611 of the male mold 610. For instance, the male mold 610 may have one or more protrusions 615 formed on the surface 611 of the male mold 610 such that, for example, in a case where a material is provided in at least one of the male mold 610 and the first female mold 680 and the male mold 610 and the first female mold 680 are fit together, a container may be formed having one or more patterns or shapes (e.g., concavities) on an inner surface of the container corresponding to the one or more protrusions 615. As a non-limiting example, the protrusions 615 may include a raised pattern of a flower, fruit, or any other image.

In some embodiments, the protrusions 615 may be formed with the male mold 610 such that, for example, the protrusions 615 and the male mold 610 form a single, unitary body. For example, the protrusions 615 may be formed on/in the male mold 610 by engraving (e.g., laser engraving), etching, water jet cutting, and/or the like. As such, the first pattern may be pre-determined to allow a corresponding pattern to be formed on an inner surface of a container, for example, in a case where a material is provided in at least one of the male mold 410 and the first female mold 680 and the male mold 610 and the first female mold 680 are fit together.

In other embodiments, the protrusions 615 may be provided on the surface 611 of the male mold 610. The protrusions 615 may be provided on the surface 611 of the male mold 610 in any suitable manner such as through, but not limited to, an adhesive material (or other suitable seal), a friction fitting, a press fitting, bonding, melting together, and/or the like. The protrusions 615 may be made of any suitably rigid material such as, but not limited to, metal (e.g., die-cast steel), plastic, glass, composite material, and/or the like.

In some embodiments, the first pattern of the male mold 610 may include one or more concavities (not shown). For instance, the male mold 610 may have one or more cavities formed therein (or thereon). As such, the male mold 610 and the first female mold 680 may be used to form a container (or portion thereof) having one or more patterns or shapes (e.g., protrusions) on an inner surface of the container corresponding to the one or more concavities, for example, in a case where a material is provided in at least one of the male mold 610 and the first female mold 680 and the male mold 610 and the first female mold 680 are fit together. As a non-limiting example, the concavities may include a depressed pattern of a flower, fruit, or any other image.

In various embodiments, the first pattern (e.g., protrusions 615, concavities, and/or the like) of the male mold 610 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the first pattern with an associated laser-engraving machine (e.g., a sealed laser-engraving machine). In various embodiments, the first pattern (e.g., protrusions 315, concavities, and/or the like) of the male mold 310 may be formed or otherwise provided through an etching process that may include, but is not limited to, forming a mold having a pattern via a reactive ion etching (RIE) method.

In step S1604 (of FIG. 6D), the first female mold 680 may be prepared (e.g., manufactured) or otherwise provided. The first female mold 680 may be configured to receive at least a portion of the male mold 610. The first female mold 680 may be made of any suitably rigid material such as, but not limited to, metal (e.g., die-cast steel), plastic, glass, composite material, and/or the like. The first female mold 680 may be manufactured according to any suitable process, including, but not limited to, with an open-die forge process, close-die forge process, and/or the like.

In various embodiments, the first female mold 680 may have a first pattern that corresponds to the first pattern of the male mold 610. In some embodiments, the first pattern of the first female mold 680 may include one or more concavities 685. For instance, the first female mold 680 may have one or more cavities 685 formed in or on a surface 681 of the first female mold 680. As such, in a case where material is provided in at least one of the male mold 610 and the first female mold 680 and the male mold 610 and the first female mold 680 are fit together, a container or portion thereof (e.g., first part 660) may be formed having one or more patterns or shapes (e.g., protrusions) corresponding to the one or more concavities 685.

In other embodiments, the surface 681 of the first female mold 680 may be relatively free of any patterns or the like. As such, for example, in a case where a material is provided in at least one of the male mold 610 and the first female mold 680 and the male mold 610 and the first female mold 680 are fit together, a container or a portion thereof (e.g., first part 660) may be formed having a surface corresponding to the surface 681 (e.g., relatively smooth) of the first female mold 680.

In some embodiments, the concavities 685 may be formed with the first female mold 680 such that, for example, the concavities 685 and the first female mold 680 form a single, unitary body. For example, the concavities 685 may be formed on/in the first female mold 680 by engraving (e.g., laser engraving), etching, water jet cutting, and/or the like. As such, the first pattern may be pre-determined to allow a corresponding pattern to be formed on a surface of a container or a portion thereof (e.g., first part 660), for example, in a case where a material is provided in at least one of the male mold 610 and the first female mold 680 and the male mold 610 and the first female mold 680 are fit together.

In various embodiments, the first pattern (e.g., concavities 685, and/or the like) of the first female mold 680 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the first pattern (e.g., concavities 685, and/or the like) of the first female mold 680 may be formed or otherwise provided through an etching process that may include, but is not limited to, forming a mold having a pattern via a reactive ion etching (RIE) method.

In step S1606 (of FIG. 6D), the second female mold 640 may be prepared (e.g., manufactured) or otherwise provided. The second female mold 640 may be configured to receive at least a portion of the male mold 610 (and/or the first part 660 of the container 650). The second female mold 640 may be made of any suitably rigid material such as, but not limited to, metal (e.g., die-cast steel), plastic, glass, composite material, and/or the like. The second female mold 640 may be manufactured according to any suitable process, including, but not limited to, with an open-die forge process, close-die forge process, and/or the like.

In various embodiments, the second female mold 640 may have a second pattern. In some embodiments, the second pattern of the second female mold 640 may include one or more protrusions 645 (i.e., a three-dimensional structure) on a surface 641 of the second female mold 640. For instance, the second female mold 640 may have one or more protrusions 645 formed on the surface 641 of the second female mold 640 such that, for example, in a case where material is provided in at least one of the male mold 610 and the second female mold 640 and the male mold 610 and the second female mold 640 are fit together, a container (or portion thereof) may be formed having one or more patterns or shapes (e.g., concavities) on an outer surface of the container corresponding to the one or more protrusions 645. As a non-limiting example, the protrusions 645 may include a raised pattern of a flower, fruit, or any other image.

In some embodiments, the protrusions 645 may be formed with the second female mold 640 such that, for example, the protrusions 645 and the second female mold 640 form a single, unitary body. For example, the protrusions 645 may be formed on/in the second female mold 640 by engraving (e.g., laser engraving), etching, water jet cutting, and/or the like. As such, the second pattern may be pre-determined to allow a corresponding pattern to be formed on an outer surface of a container (or portion thereof), for example, in a case where a material is provided in at least one of the male mold 610 and the second female mold 640 and the male mold 610 and the second female mold 640 are fit together.

In some embodiments, the protrusions 645 may be provided on the surface 641 of the second female mold 640. The protrusions 645 may be provided on the surface 641 of the second female mold 640 in any suitable manner such as through, but not limited to, an adhesive material (or other suitable seal), a friction fitting, a press fitting, bonding, melting together, and/or the like. The protrusions 645 may be made of any suitably rigid material such as, but not limited to, metal (e.g., die-cast steel), plastic, glass, composite material, and/or the like.

In some embodiments, the second pattern of the second female mold 640 may include one or more concavities (not shown). For instance, the second female mold 640 may have one or more cavities formed therein (or thereon). As such, the male mold 610 and the second female mold 640 may be used to form a container (or portion thereof) having one or more patterns or shapes (e.g., protrusions) on an outer surface of the container (or portion thereof) corresponding to the one or more concavities, for example, in a case where a material is provided in at least one of the male mold 610 and the second female mold 640 and the male mold 610 and the second female mold 640 are fit together. As a non-limiting example, the concavities may include a depressed pattern of a flower, fruit, or any other image.

In various embodiments, the second pattern (e.g., protrusions 645, concavities, and/or the like) of the second female mold 640 may be formed or otherwise provided through a laser engraving process that may include, but is not limited to, providing (e.g., uploading) a pattern for engraving a mold to a computing device (not shown) or the like. The computing device may be configured to use computer graphics software, such as, but not limited to, AutoCAD, Corel Draw, and/or the like to engrave the mold with the pattern with an associated laser-engraving machine (e.g., a sealed laser-engraving machine). In various embodiments, the second pattern (e.g., protrusions 645, concavities, and/or the like) of the second female mold 640 may be formed or otherwise provided through an etching process that may include, but is not limited to, forming a mold having a pattern via a reactive ion etching (RIE) method.

In step S1608 (of FIG. 6D), a first material may be injected, placed, or otherwise provided into (or onto) at least one of the molds. For instance, in some embodiments, the first material may be injected into the first female mold 680. In some embodiments, the first material (or other material) may be injected or placed on the male mold 610. The first material may be injected, placed, or otherwise provided into (or onto) the at least one of the molds manually, through associated machinery, and/or the like.

In various embodiments, the first material may be a melamine material, such as, but not limited to, a melamine resin material (e.g., M230 manufactured by Chia Yeh Plastic Co., Ltd.). In some embodiments, the first material may be, but is not limited to, any one of or combination of: wood pulp (e.g., bamboo fiber), paper, starch, acrylic, materials having at least some melamine material, resins, microwaveable material resins, and/or the like. For example, in some embodiments, the first material may include a melamine material (e.g., resin) formed by adding bamboo fiber (or the like) to melamine powder. In some embodiments, the first material may be white. In other embodiments, the first material may be one or more colors.

In step S1610 (of FIG. 6D), the male mold 610 and the first female mold 680 of the mold set 600 may be fit together. In some embodiments, the first material may be injected, placed, or otherwise provided into one (or both) of the molds (i.e., step S1608) after the male mold 610 and the first female mold 680 have already been fit together (i.e., after step S1610).

Next, instep S1612 (of FIG. 6D), a first part 660 of the container 650 maybe formed with the mold set 600. For instance, in a case where the first material has been injected (or otherwise provided) into one of the molds (e.g., the first female mold 680) and the male mold 610 and the first female mold 680 are fit together, the first part 660 of the container 650 may be formed, for example, through an extrusion molding process. The first part 660 of the container 650 may have an inner surface 661 and an outer surface 663.

The outer surface 663 may have one or more patterns or shapes corresponding to the first pattern of the first female mold 680. For example, in a case where the first female mold 680 is provided with the cavities 685, protrusions 664 corresponding to the one or more cavities 685 may be formed in the outer surface 663 of the first part 660 of the container 650. The inner surface 661 may have one or more patterns or shapes corresponding to the first pattern of the first female mold 680. For example, in a case where the first female mold 680 is provided with the protrusions, concavities corresponding to the one or more protrusions may be formed in the inner surface 661 of the first part 660 of the container 650. The container 650 (or the first part 660) may have an interior space 659 formed therein, for example, by the male mold 610.

Instep S1614 (of FIG. 6D), a second material maybe injected, placed, or otherwise provided into (or onto) at least one of the molds. For instance, in some embodiments, the second material may be injected into the second female mold 640, and in some embodiments, the second material (or other material) may be injected or placed on the male mold 610 (e.g., on the first part 660). The second material may be injected, placed, or otherwise provided into (or onto) the at least one of the molds manually, through associated machinery, and/or the like. In further embodiments, the associated machinery may be the same machinery for providing the first material. In other embodiments, the associated machinery may be different from the machinery for providing the first material.

In various embodiments, the second material may be a melamine material, such as, but not limited to, a melamine resin material (e.g., M230 manufactured by Chia Yeh Plastic Co., Ltd.). In some embodiments, the second material may be, but is not limited to, any one of or combination of: wood pulp (e.g., bamboo fiber), paper, starch, acrylic, materials having at least some melamine material, resins, microwaveable material resins, and/or the like. For example, in some embodiments, the second material may include a melamine material (e.g., resin) formed by adding bamboo fiber (or the like) to melamine powder. In some embodiments, the second material may be white. In other embodiments, the second material may be one or more colors. In some embodiments, the second material may be different (e.g., in color, material, texture, and/or the like) from the first material. In other embodiments, the second material may be the same as the first material.

In step S1616 (of FIG. 6D), the male mold 610 and the second female mold 640 of the mold set 600 may be fit together. The first part 660 and the male mold 610 may be fit with the second female mold 640. In some embodiments, the second material may be injected, placed, or otherwise provided into one (or both) of the molds (i.e., step S 1614) after the male mold 610 and the second female mold 640 have already been fit together (i.e., after step S1616).

Next, instep S1618 (of FIG. 6D), a second part 670 of the container 650 maybe formed with the mold set 600. The first part 660 and the second part 670 may form the container 650. For instance, in a case where the second material has been injected (or otherwise provided) into one of the molds (e.g., the second female mold 640) and the male mold 610 (and/or the first part 660) and the second female mold 640 are fit together, the second part 670 of the container 650 may be formed, for example, through an extrusion molding process. The second part 670 of the container 650 may have an inner surface 671 and an outer surface 673.

The outer surface 673 may have one or more patterns or shapes corresponding to the second pattern of the second female mold 640. For example, in a case where the second female mold 640 is provided with the protrusions 645, concavities 674 corresponding to the one or more protrusions 645 may be formed in the outer surface 673 of the second part 670 of the container 650. The inner surface 671 may have one or more patterns or shapes corresponding to the first pattern of the male mold 610 (or the protrusions 664 of the first part 660). For example, in a case where the male mold 610 is provided with the protrusions 615 (or the protrusions 664 of the first part 660), concavities 672 corresponding to the protrusions 615 (or the protrusions 664) may be formed in the inner surface 671 of the second part 670 of the container 650.

The outer surface 663 of the first part 660 may be adjacent the inner surface 671 of the second part 670. In some embodiments, the outer surface 663 of the first part 660 may be adjacent (e.g., in contact with) the inner surface 671 of the second part 670. In some embodiments, an intermediate layer (not shown) may be provided between the first part 660 and the second part 670, for example, in contact with the outer surface 663 of the first part 660 and/or the inner surface 671 of the second part 670. The intermediate layer may be formed according to, but not limited to, any of the methods for providing a container in its entirety (e.g., the container 150, 250, 350, 450, 550 as described with respect to FIGS. 1A-5D) or a portion (e.g., the first part 660, the second part 670, and/or the like) of a container.

In various embodiments, the male mold 610 may have a width dimension F1. The accommodating space 689 of the first female mold 680 may have a width dimension F2. The accommodating space 649 of the second female mold 640 may have a width dimension F3. Thus in various embodiments where a first part 660 of a container 650 is formed using the male mold 610 and the first female mold 680, the first part 660 of the container 650 may have a width dimension F2 that may be the same as the width dimension F2 of the accommodating space 689 of the first female mold 680. The interior space of the first part 660 of the container 650 may have a width dimension F1 that may be the same as the width dimension F1 of the male mold 610. In various embodiments, the width dimension F1 may range from, but is not limited to, 2.2″ to 45″, the width dimension F2 may range from, but is not limited to, 2.6″ to 47.5″, and the width dimension F3 may range from, but is not limited to, 3″ to 50″. Thus in such embodiments, the container may have a thickness ranging from, but not limited to, 0.8″ to 5″.

In embodiments where a second part 670 of the container 650 is formed with the first part 660 using the male mold 610 and the second female mold 640, the second part 670 of the container 650 may have a width dimension F3 that may be the same as the width dimension F3 of the interior space 649 of the second female mold 640. The interior space of the second part 670 of the container 650 may have a width dimension F2 that is the same as the width dimension F2 of the first part 660. Thus in various embodiments, the first part 660 and the second part 670 may form the container 650 such that a width dimension F3 of the container 650 may be the same as the width dimension F3 of the accommodating space 649 of the second female mold 640, and the interior space 659 of the container 650 may have a width dimension F1 that may be the same as the width dimension F1 of the male mold 610.

In further embodiments, in step S1620 (of FIG. 6D) a process for applying at least one color layer (e.g., a film, decal, and/or the like) material to the container 650 may be employed. In some embodiments, the color layer material may be a single color. In other embodiments, the color layer material may be a plurality of colors.

With respect to the process of step S1620, first, in step S1622 (of FIG. 6D), at least one color layer material may be arranged on one or more of the molds of the mold set 600. For instance, in some embodiments, a first color layer material 675 may be arranged on the second pattern (e.g., the protrusions 645) of the second female mold 640 and/or a second color layer material 665 may be arranged on the first pattern (e.g., protrusions 615) of the male mold 610.

In other embodiments, one or both of the color layer materials 665, 675 may be arranged on portions of their respective mold, in addition to in alternative to the pattern the respective mold. In some embodiments, one or both of the color layer materials 665, 675 may be provided on the first part 660 and/or the second part 670, respectively, of the container 650, for example, at least in the concavities 662 of the first part 660 and/or the concavities 674 of the second part 670, respectively, of the container 650.

In step S1624 (of FIG. 6D), the male mold 610 may be compressed with the second female mold 640 to apply the one or both of the color layer material 665, 675 to the container 650. In other embodiments, the one or both of the color layer materials 665, 675 may be provided on their respective molds prior to the molds being used to form one or more of the first part 660 and the second part 670. Thus in such embodiments, the color layer materials 665, 675 may be applied as one or more of the first part 660 and the second part 670 are formed (e.g., step S1612 and/or S1618).

In step S1626 (of FIG. 6D), a coating powder (not shown) or glazing powder, such as an over-lay resin (e.g., LG-110, LG-220, LG-250) and/or the like may be applied to one or both of the color layer materials 665, 675 on the container 650. The coating powder, for example, may prevent the color layer materials 665, 675 from peeling off the container 650. In step S1628 (of FIG. 6D), the male mold 610 may be compressed, for example via heat compressing, with the second female mold 640 to mold the color layer materials 665, 675 on the container 650. In other embodiments, the male mold 610 may be compressed, for example via heat compressing, with the second female mold 640 to mold the color layer materials 665, 675 on the container 650 without applying the coating powder.

In various embodiments, the mold set 600 (or component(s) thereof) may be placed in or otherwise employed with a molding machine (not shown) (e.g., an extrusion molding machine) during step S1608 and/or S1614 (e.g., to provide the material). In some embodiments, the mold set 600 (or component(s) thereof) may be placed in or otherwise employed with the molding machine during step S1612 and/or S1618 (e.g., to form the first part 660 and/or the second part 670 of the container 650). The molding machine may be the same device as the associated machinery for providing the material. In other embodiments, the molding machine may be a different device from the associated machinery for providing the material.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A method of manufacturing a container, the method comprising:
providing a female mold and a male mold, at least one of the male mold and the female mold having a predetermined pattern formed thereon;
providing a material to at least one of the male mold and the female mold; and
forming a container from at least the material with the male mold and the female mold such that the container is formed with at least one of a pattern corresponding to the predetermined pattern of the male mold on an inner surface and a pattern corresponding to the predetermined pattern of the female mold on an outer surface of the container.

2. The method of claim 1, the method further comprising:
providing a layer on at least one of the pattern of the container and the predetermined pattern of the at least one of the male mold and the female mold; and
heat compressing the layer to the container.

3. The method of claim 2, wherein the layer comprises a color material film having one or more colors.

4. The method of claim 1, wherein the predetermined pattern of the at least one of the male mold and the female mold comprises at least one of one or more protrusions and one or more concavities.

5. The method of claim 1, wherein the material comprises a melamine material.

6. A method of manufacturing a container, the method comprising:
providing a female mold having a predetermined pattern formed thereon;
providing a male mold having a predetermined pattern formed thereon;
providing material to at least one of the female mold and the male mold; forming a container from at least the material with the male mold and the female mold such that the container is formed with a first pattern on an outer surface of the container and a second pattern on an inner surface of the container, the first pattern corresponding to the predetermined pattern of the female mold, the second pattern corresponding to the predetermined pattern of the male mold.

7. The method of claim 6, the method further comprising:
providing a first layer on at least one of (1) at least one of the first pattern of the container and the predetermined pattern of the male mold and (2) at least one of the second pattern of the container and the predetermined pattern of the female mold; and
heat compressing the first layer to the container.

8. The method of claim 7, wherein the first layer comprises a color material film having one or more colors.

9. The method of claim 7, the method further comprising:
providing a second layer on at least one of (1) the other of the at least one of the predetermined pattern of the male mold and the predetermined pattern of the second female mold, relative to the at least one of the predetermined pattern of the male mold and the predetermined pattern of the second female mold provided with the first layer, and (2) the pattern of the container corresponding to the other of the at least one of the predetermined pattern of the male mold and the predetermined pattern of the second female mold, relative to the at least one of the predetermined pattern of the male mold and the predetermined pattern of the second female mold provided with the first layer; and
compressing the second layer to the container by heat treatment.

10. The method of claim 6,
wherein the predetermined pattern of the male mold comprises at least one of one or more protrusions and one or more concavities; and
wherein the predetermined pattern of the female mold comprises at least one of one or more protrusions and one or more concavities.

11. The method of claim 6, wherein the material comprises a melamine material.

12. The method of claim 6, wherein the predetermined pattern of the male mold is different from the predetermined pattern of the female mold.

13. A method of manufacturing a container, the method comprising:
providing a female mold;
providing a first male mold;
providing a second male mold having a predetermined pattern formed thereon;
providing a first material to at least one of the female mold and the first male mold;
forming a first part of a container from at least the first material with the first male mold and the female mold;
providing a second material to at least one of the first part of the container placed on the female mold and the second male mold; and
forming a second part of the container from at least the second material with the second male mold and the female mold to form the container such that the container is formed with a pattern on an inner surface of the molded container, the pattern corresponding to the predetermined pattern of the second male mold.

14. The method of claim 13, wherein the second material is different from the first material.

15. The method of claim 13, wherein the second material has a color different from a color of the first material.

16. The method of claim 13, wherein at least one of the first material and the second material comprises a melamine material.

17. The method of claim 13, wherein the predetermined pattern of the second male mold comprises at least one of one or more protrusions and one or more concavities.

18. The method of claim 13, the method further comprising:
providing a layer on at least one of the pattern of the container and the predetermined pattern of the second male mold; and
compressing the layer to the container by heat treatment.

19. The method of claim 18, wherein the layer comprises a color material film having one or more colors.

20. A method of manufacturing a container, the method comprising:
providing a first female mold;
providing a second female mold having a predetermined pattern formed thereon;
providing a male mold;
providing a first material to at least one of the first female mold and the male mold;
forming a first part of a container from at least the first material with the male mold and the first female mold;
providing a second material to at least one of the second female mold, the first part of the container, and the male mold; and
forming a second part of the container from at least the second material with the second female mold and at least one of the male mold and the first part of the container to form the container such that the container is formed with a pattern on an outer surface of the container, the pattern corresponding to the predetermined pattern of the second female mold.

21. The method of claim 20, wherein the second material is different from the first material.

22. The method of claim 20, wherein the second material has a color different from a color of the first material.

23. The method of claim 20, wherein at least one of the first material and the second material comprises a melamine material.

24. The method of claim 20, wherein the predetermined pattern of the second female mold comprises at least one of one or more protrusions and one or more concavities.

25. The method of claim 20, the method further comprising:
providing a layer on at least one of the pattern of the container and the predetermined pattern of the second female mold; and
compressing the layer to the container by heat treatment.

26. The method of claim 25, wherein the layer comprises a color material film having one or more colors.

27. A method of manufacturing a container, the method comprising:
providing a male mold having a predetermined pattern formed thereon;
providing a first female mold having a predetermined pattern formed thereon;
providing a second female mold having a predetermined pattern;
providing a first material to at least one of the first female mold and the male mold;
forming a first part of a container from at least the first material with the male mold and the first female mold;
providing a second material to at least one of the second female mold, the first part of the container, and the male mold; and
forming a second part of the container from at least the second material with the second female mold and at least one of the male mold and the first part of the container to form the container such that the container is formed with a first pattern on an outer surface of the container and a second pattern on an inner surface of the container, the first pattern corresponding to the predetermined pattern of the male mold, the second pattern corresponding to the predetermined pattern of the second female mold.

28. The method of claim 27, wherein the predetermined pattern of the first female mold corresponds to the predetermined pattern of the male mold.

29. The method of claim 27, wherein the second material is different from the first material.

30. The method of claim 27, wherein the second material has a color different from a color of the first material.

31. The method of claim 27, wherein at least one of the first material and the second material comprises a melamine material.

32. The method of claim 27, wherein the predetermined pattern of the male mold is different from the predetermined pattern of the second female mold.

33. The method of claim 27, the method further comprising providing a first layer on at least one of (1) at least one of the first pattern of the container and the predetermined pattern of the male mold and (2) at least one of the second pattern of the container and the predetermined pattern of the second female mold; and
compressing the first layer to the container by heat treatment.

34. The method of claim 33, wherein the first layer comprises a color material film having one or more colors.

35. The method of claim 33, the method further comprising
providing a second layer on at least one of (1) the other of the at least one of the predetermined pattern of the male mold and the predetermined pattern of the second female mold, relative to the at least one of the predetermined pattern of the male mold and the predetermined pattern of the second female mold provided with the first layer, and (2) the pattern of the container corresponding to the other of the at least one of the predetermined pattern of the male mold and the predetermined pattern of the second female mold, relative to the at least one of the predetermined pattern of the male mold and the predetermined pattern of the second female mold provided with the first layer; and
compressing the second layer to the container by heat treatment.

36. The method of claim 27,
wherein first predetermined pattern of the male mold comprises at least one of one or more protrusions and one or more concavities; and
wherein second predetermined pattern of the second female mold comprises at least one of one or more protrusions and one or more concavities.

37. A method of manufacturing a container, the method comprising:
providing a container formed from at least a material using a female mold and a male mold, at least of the male mold and the female mold having a predetermined pattern formed thereon such that the container is formed with at least one of a pattern corresponding to the predetermined pattern of the male mold on an inner surface and a pattern corresponding to the predetermined pattern of the female mold on an outer surface of the container; and
providing a layer by heat compressing the layer on at least one of the pattern of the container and the predetermined pattern of the at least one of the male mold and the female mold.
